(19) United States
(12) Patent Application Publication
(10) Pub. No.: US 2024/0232943 A1
(43) Pub. Date: Jul. 11, 2024

(54) INTEGRATING DIGITAL PLATFORMS INTO PROGRAMMATIC VIRTUAL ENVIRONMENTS

(71) Applicant: Nicholas Francesco LONGANO, West Palm Beach, FL (US)

(72) Inventor: Nicholas Francesco LONGANO, West Palm Beach, FL (US)

(21) Appl. No.: 18/404,637

(22) Filed: Jan. 4, 2024

Related U.S. Application Data
(63) Continuation of application No. 16/875,251, filed on May 15, 2020, now Pat. No. 11,869,037.
(60) Provisional application No. 62/849,680, filed on May 17, 2019.
(60) Provisional application No. 63/437,026, filed on Jan. 4, 2023.

(51) Int. Cl. G06Q 30/0251; G06N 5/04; G06N 20/00

(52) U.S. Cl. CPC G06Q 30/0254; G06N 5/04; G06N 20/00

(57) ABSTRACT

The exemplary embodiments include processes that integrate computer-implemented digital platforms into programmatically generated virtual environments. For example, based on a first signal received from a computing device operable by a user, an apparatus may determine that an element of digital content is consistent with a prior interaction between the user and a digital platform. The element of digital content may be associated with data exchange of data involving the digital platform, and the apparatus may transmit a second signal that includes the element of first digital content and information characterizing the data exchange to the computing device. The computing device may present the element of digital content within a digital interface associated with an executed application program, and based on the presentation, the computing device request an initiation of the data exchange at the apparatus without exiting a virtual environment of the executed application program.

### CROSS-REFERENCE TO RELATED APPLICATIONS

This application claims the benefit of priority to pending U.S. Provisional Application No. 64/437,026, filed Jan. 4, 2023, and is a continuation-in-part of, and claims the benefit of priority to, pending U.S. application Ser. No. 16/875,251, filed May 15, 2020, which claims the benefit of priority to U.S. Provisional Application No. 62/849,680, filed May 17, 2019. The disclosures of each of these provisional and non-provisional applications are incorporated by reference to their entireties.

### TECHNICAL FIELD

The disclosed embodiments generally relate to computer-implemented systems and processes that integrate computer-implemented digital platforms into programmatically generated virtual environments.

### BACKGROUND

Today, the popularity of online or digital gaming continues to increase among certain age groups of particular interest to digital retailers and other merchants. In many instances, however, conventional processes for targeting digital content to potential users of a gaming or other immersive, virtual environment not only distract these potential users from the gaming or other immersive, virtual environment, but also provide content of limited relevance to the potential users that requires these potential users to exist the gaming or other immersive, virtual environment prior to interacting with digital portals or web pages associated with merchants or retailers. As such, these conventional processes often result in limited engagement between the potential users and the retailers or merchants, while significantly decreasing the engagement of these potential uses with the gaming or other immersive, virtual environment.

### SUMMARY

In some examples, an apparatus includes a transceiver device, a non-transitory, computer-readable medium storing instructions, and at least one processor coupled to the transceiver device and the computer-readable medium. The at least one processor is configured to execute the instructions to receive a first signal from a computing device via the-transceiver device. The computing device is operable by a user, and the first signal being generated by an application program executed by the computing device. The at least one processor is further configured to execute the instructions to determine that a first element of digital content is consistent with at least one prior interaction between the user and a first digital interface of a digital platform associated with a plurality of application programs. The plurality of application programs includes the executed application program. The at least one processor is further configured to execute the instructions to transmit, via the transceiver device, a second signal that includes the element of first digital content to the computing device. The executed application program causes the computing device to present second elements of digital content within a second digital interface associated with the executed application program, to present the first element of digital content within the second digital interface at a position that obscures at least one of the second elements of digital content, and to generate a request for an exchange of data associated with first element of digital content without exiting a virtual environment associated with the executed application program. The at least one processor is further configured to execute the instructions to receive, via the transceiver device, a third signal that includes the request from the computing device, and perform operations that execute the data exchange in accordance with the request.

In other examples, an apparatus includes a transceiver device, a non-transitory, computer-readable medium storing instructions, and at least one processor coupled to the transceiver device and the computer-readable medium. The at least one processor is configured to execute the instructions to receive a first signal from a computing device via the-transceiver device. The computing device is operable by a user, and the first signal is generated by an application program executed by the computing device. The at least one processor is further configured to execute the instructions to determine that a first element of digital content is consistent with at least one prior interaction between the user and a first digital interface of a digital platform associated with a plurality of application programs. The first element of digital content is associated with an exchange of data involving the digital platform. The at least one processor is further configured to execute the instructions to transmit, to the computing device via the transceiver device, a second signal that includes the element of first digital content and information characterizing the data exchange. The executed application program causes the computing device to present second elements of digital content within a second digital interface associated with the executed application program, to present the first element of digital content within the second digital interface at a position that obscures at least one of the second elements of digital content, and based on the presentation of the first element of digital content, to generate a request to initiate the data exchange associated with first element of digital content without exiting a virtual environment associated with the executed application program. The at least one processor is further configured to execute the instructions to receive, via the transceiver device, a third signal that includes the request from the computing device, and to perform operations that execute the data exchange in accordance with the request.

Further, in some examples, a computer-implemented method includes receiving a first signal from a computing device using at least one processor. The computing device is operable by a user, and the first signal is generated by an application program executed by the computing device. The computer-implemented method includes determining, using the at least one processor, that a first element of digital content is consistent with at least one prior interaction between the user and a first digital interface of a digital platform associated with a plurality of application programs. The first element of digital content is associated with an exchange of data involving the digital platform. The computer-implemented method includes transmitting, to the computing device using the at least one processor, a second signal that includes the element of first digital content and information characterizing the data exchange. The executed application program causes the computing device to present second elements of digital content within a second digital interface associated with the executed application program, to present the first element of digital content within the second digital interface at a position that obscures at least one of the second elements of digital content, and based on the presentation of the first element of digital content, to generate a request to initiate the data exchange associated with first element of digital content without exiting a virtual environment associated with the executed application program. The computer-implemented method includes, using the at least one processor, receiving a third signal that includes the request from the computing device, and performing operations that execute the data exchange in accordance with the request.

It is to be understood that both the foregoing general description and the following detailed description are exemplary and explanatory only and are not restrictive of the invention, as claimed. Further, the accompanying drawings, which are incorporated in and constitute a part of this specification, illustrate aspects of the present disclosure and together with the description, serve to explain principles of the disclosed embodiments as set forth in the accompanying claims.

### BRIEF DESCRIPTION OF THE DRAWINGS

FIG. 1 is a block diagram of an exemplary computing environment, in accordance with some embodiments;

FIG. 2 is a block diagram of an exemplary computing device, in accordance with some embodiments;

FIG. 3 is a diagram illustrating portions of an exemplary computing environment, in accordance with some embodiments;

FIGS. 4A, 4B, 4C, 4D, 4E, 4F, 4G, and 4H illustrate portions of an exemplary graphical user interface, in accordance with some embodiments;

FIGS. 5A and 5B are flowcharts of exemplary processes for matching game environments and product advertisements, in accordance with some embodiments;

FIG. 6 is a flowchart of an exemplary process for providing product advertisements for a user, in accordance with some embodiments;

FIG. 7 is a flowchart of an exemplary process for obtaining and exchanging marketplace credits, in accordance with some embodiments;

FIG. 8A is a diagram illustrating portions of an exemplary computing environment, in accordance with some embodiments;

FIGS. 8B-8E illustrate portions of an exemplary graphical user interface, in accordance with some embodiments;

FIG. 8F is a diagram illustrating portions of an exemplary computing environment, in accordance with some embodiments;

FIGS. 8G and 8H illustrate portions of an exemplary graphical user interface, in accordance with some embodiments;

FIG. 9 is diagram illustrating portions of an exemplary computing environment, in accordance with some embodiments; and

FIGS. 10A, 10B, and 10C are flowcharts of exemplary processes for integrating computer-implemented digital platforms into programmatic virtual environments, in accordance with some embodiments.

### DETAILED DESCRIPTION

Reference will now be made in detail to the disclosed embodiments, examples of which are illustrated in the accompanying drawings. The same reference numbers in the drawings and this disclosure are intended to refer to the same or like elements, components, and/or parts.

In this application, the use of the singular includes the plural unless specifically stated otherwise. In this application, the use of “or” means “and/or” unless stated otherwise. Furthermore, the use of the term “including,” as well as other forms such as “includes” and “included,” is not limiting. In addition, terms such as “element” or “component” encompass both elements and components comprising one unit, and elements and components that comprise more than one subunit, unless specifically stated otherwise.

This application relates to computer-implemented apparatuses, methods, and processes that provide a computer-implemented digital platform accessible directly through executed application programs that integrate a software development kit (SDK) associated with the computer-implemented, marketplace platform. The computer-implemented, marketplace platform may, for example, match together candidate advertising content to these executed application programs and to the users of these applications, and may provision the matched advertising content to these executed applications for presentation within a corresponding platform-specific graphical user interface (GUI).

In some examples, the computer-implemented digital platform may be associated with an electronic marketplace, and executable applications programs may include a gaming application that, upon execution by a computing system or device, presents one or more elements of digital content within a corresponding gaming interface, which collectively establishes the gaming environment. The one or more elements of digital content may also include a selectable interface element that, upon selection by a user, triggers the presentation by the executed gaming application, of the platform-specific GUI with the gaming interface. The platform-specific GUI may, for example, obscure all or a selected portion of the digital content establishing the gaming environment, and may enable the user to interact with the electronic marketplace within exiting the gaming environment.

Further, the advertising content presented within the platform-specific GUI may be appropriate to the gaming application and further, tailored to the interests of the user and to the user's prior interactions with both the gaming environment and the electronic marketplace. Further, in certain exemplary embodiments, the electronic marketplace described herein may aggregates multiple users across multiple gaming environments, and may enable these users to purchase products or services associated with the targeted advertising content without exiting the gaming environment. Further, and responsive to each purchase by a user, the digital platform may perform any of the exemplary processes described herein to allocate units of marketplace credits to the user, which may be exchanged for in-game credits and rewards, for real-world products or services, or for units of currency.

A. Computer-Implemented Integration of Digital Platforms into Programmatically Generated Virtual Environment

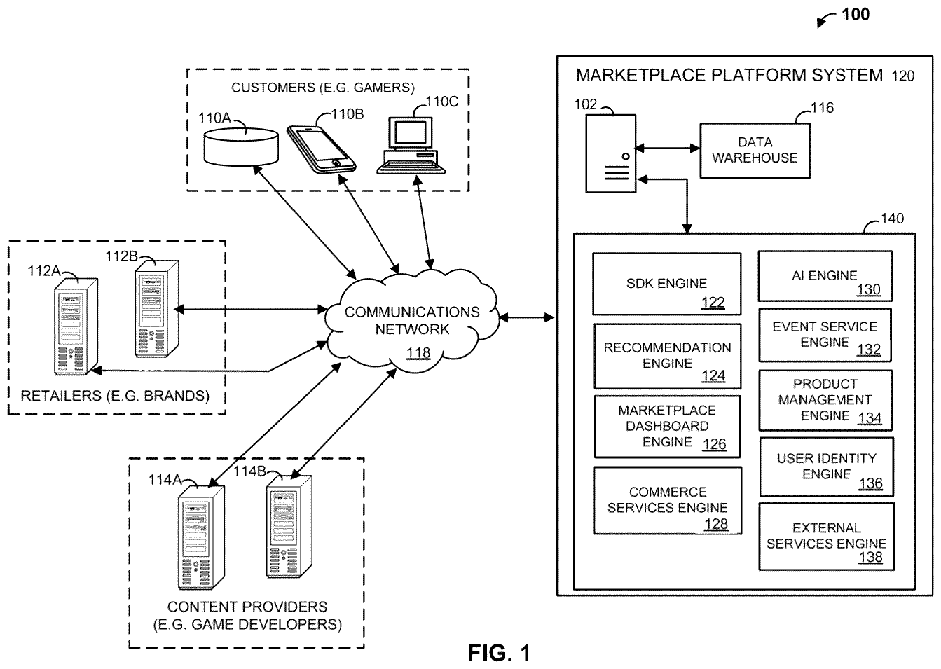

FIG. 1 is a diagram illustrating an exemplary computing environment 100, consistent with certain disclosed embodiments. For example, as illustrated in FIG. 1, computing environment 100 may include a marketplace platform system 120, one or more customer computing devices 110A, 110B, and 110C, one or more retailer computing systems 112A and 112B, and one or more content-provider computing systems 114A and 114B, each of which may be operatively connected to communications network 118. The disclosed embodiments are, however, not limited to these exemplary computing systems and devices, and in other examples, environment 100 may include any additional, or alternate, number or type of marketplace platform systems, customer computing devices, retailer computing devices, and content provider computing devices that collectively implement the exemplary processes described herein.

In some instances, each of retailer computing systems 112A and 112B may be operable by a corresponding retailer, merchant, or other business entity that offers branded products or services to customer. Further, each of customer computing devices 110A, 110B, and 110C may be operated by a corresponding user, and each of customer computing devices 110A, 110B, and 110C may locally store, and execute, one or more application programs, which include, but are not limited to, a mobile application program, a web browser, and a gaming application. Additionally, in some examples, each of content provider computing systems 114A and 114B may be a developer of one or more of the application programs executed at customer computing devices 110A, 110B, and 110C.

By way of example, the one or more application programs executed by customer computing devices 110A, 110B, and 110C may include a gaming application, and the users that operate customer computing devices 110A, 110B, and 110C may represent “gamers” that interact with and play a video game associated with the gaming application. In some instances, one or more of content-provider computing systems 114A and 114B may be configured to perform operations that provision the gaming application to corresponding ones of customer computing devices 110A, 110B, and 110C and additionally, or alternatively, that provision one or more video games to the gaming application or to an additional application program, such as a web browser, executed by one or more of customer computing devices 110A, 110B, 110C. For example, one or more of content provider computing systems 114A and 114B may include server that hosts the video games, and an application program executed by one or more of customer computing devices 110A, 110B, 110C, such as the gaming application or the web browser, may establish a secure channel of communications with one or more of content-provider computing systems 114A and 114B (e.g., over communication network 118), and may access digital content associated with one or more of the hosed video games for presentation within a corresponding interface, e.g., to enable the user to interact with and play the one or more video games.

Examples of communications network 118 include, but are not limited to, a wireless local area network (LAN), e.g., a “Wi-Fi” network, a network utilizing radio-frequency (RF) communication protocols, a Near Field Communication (NFC) network, a wireless Metropolitan Area Network (MAN) connecting multiple wireless LANs, and a wide area network (WAN), e.g., the Internet. In some instances, the devices and systems operating within environment 100 may perform operations that establish and maintain one or more secure channels of communication across network 118, such as, but not limited to, a transport layer security (TSL) channel, a secure socket layer (SSL) channel, or any other suitable secure communication channel.

In some embodiments, marketplace platform system 120 may include one or more marketplace computing devices 102 (e.g., servers, such as cloud-based servers) having one or more tangible, non-transitory memories that store data and/or software instructions, such as instruction memory 140, and one or more processors, configured to execute the software instructions. The one or more tangible, non-transitory memories may, in some examples, store application programs, application modules, and other elements of code executable by the one or more processors.

For example, as illustrated in FIG. 1, marketplace platform system 120 may maintain, within instruction memory 140, executable software instructions that include, but are not limited to, a software development kit (SDK) engine 122, a recommendation engine 124, a marketplace dashboard engine 126, a commerce services engine 128, an artificial intelligence (AI) engine 130, an event service engine 132, a product management engine 134, a user identity engine 136, and an external services engine 138.

Although in this example each of SDK engine 122, recommendation engine 124, marketplace dashboard engine 126, commerce services engine 128, artificial intelligence (AI) engine 130, event service engine 132, product management engine 134, user identity engine 136, and external services engine 138 are implemented as executable software instructions stored within instruction memory 140 and executed by one or more processors, in other embodiments one or more of SDK engine 122, recommendation engine 124, marketplace dashboard engine 126, commerce services engine 128, artificial intelligence (AI) engine 130, event service engine 132, product management engine 134, user identity engine 136, and external services engine 138, or portions thereof, may be implemented in hardware (e.g., in an FPGA, ASIC, using discrete logic, etc.).

SDK engine 122 may, upon execution, perform operations that provision a software development kit (SDK) to one or more of content provider computing systems 114A and 114B. In some instances, the provisioned SDK may be integrated into an application program, such as, but not limited to, a gaming program, which may be provisioned to and executed by one or more of customer computing devices 110A, 110B, and 110C. By integrating the SDK into the application program (e.g., the gaming application), the execution of the application program and the integrated SDK may enable the application program to interact with, and to participate in, an electronic marketplace established and maintained by marketplace platform system 120 using any of the exemplary processes described herein.

In some instances, the integrated and executed SDK may cause the application program (e.g., the gaming application) to generate and present a graphical user interface (GUI) that facilitates access to the marketplace platform system 120. For example, a user interacting with a gaming application may, while playing a corresponding video game, may engage or select a marketplace icon within the video game, which may cause the executed gaming application (and integrated SDK) to display the GUI, which providing the user access to a marketplace hosted by the marketplace platform system 120. As described herein, the presented GUI may obscure at least a portion of the digital content generated by the executed application program (e.g., the gaming application), or alternatively, may obscure the digital content generated by the executed gaming application, and the executed gaming application may access the GUI, and the marketplace, without exiting the video game. In some instances, also described herein, the user may elect to purchase products and services offered for sale through the GUI, and the game developers (e.g., associated with corresponding one of content provider computing systems 114A and 114B) may receive a revenue share of purchases made through their games on the marketplace.

In further example, the integration of the SDK into the application program (e.g., the gaming application, another application program, etc.) may cause the executed application to monitor an interaction of the user with the executed application program and the GUI, and to perform operations that cause the corresponding one of customer computing devices 110A, 110B, or 110B to transmit data, e.g., event data characterizing the monitored interaction to marketplace platform system 120. By way of example, and for the gaming application, the event data may identify actions a user takes within the game such as, for example, the activation of the marketplace icon, the viewing of product advertisements, and purchases made by the user from the marketplace.

Event data may also identify the creation of a new user account at marketplace platform system 120, which may include user profile data. For example, and using certain of the processes described herein, a user playing a game hosted by content provider computing system 114A may engage a marketplace icon displayed within the game and, in response, may be prompted by one or more interface elements of the presented GUI to create a marketplace account (e.g., via an icon that displays “Click here to create account”). In response, the user may provide, as input to a corresponding one of customer computing devices 110A, 110B, or 110C, one or more login or authentication credentials (e.g., alphanumeric username and password), which the corresponding one of customer computing devices 110A, 110B, or 110C may transmit across network 118 to marketplace platform system 120 via a secure, programmatic interface. In some instances, marketplace platform system 120 may perform operations that generate new user account data identifying the login and authentication data, which may be locally stored within a data repository (e.g., data warehouse 116), and which may identify the user across additional or alternate video game operable with marketplace platform system 120 and the marketplace. The marketplace account created may be valid and accessible from a plurality of games that include an integrated SDK.

Further, elements of the event data may identify when a user views a particular product advertisement within the GUI, purchases a product through the GUI, or logs into or out of the marketplace (e.g., based on input provided to the GUI). The elements of the event data may also characterize the user's interaction with an executed gaming application, such as, but not limited to, identifying the user's progress in game play, e.g., by identifying a number of point the user has achieved in a game or a game level that the user has reached in the game. The disclosed embodiments are, however, not limited to gaming applications, and in other instances, the elements of the event data may identify and characterize the user's interaction with any additional, or alternate, application program integrating the provisioned SDK and executable by customer computing devices 110A, 110B, and 110C.

In some examples, each of the executed application programs, such as the gaming application described herein, may perform operations (via the integrated SDK) that cause a corresponding one of customer computing devices 110A, 110B, or 110C to transmit the generated elements of event data across network 118 to marketplace platform system 120. A programmatic interface established and maintained by marketplace platform system 120, such as an application programming interface (API) may receive and route the elements of event data to event service engine 132 (e.g., directly or via SDK engine 122), which may store the elements of event data within data warehouse 116.

User identity engine 136 may, upon execution, perform operations that manage and federate user profiles and a creation of corresponding user accounts that the marketplace that can be accessed across applications programs and gaming applications that integrated the SDK described herein. For example, event service engine 132 may receive, from an SDK integrated into a gaming application executed by customer computing device 110A, 110B, or 110C, event data that includes user data (e.g., user profile data) that requests a creation of a new user account. Event service engine 132 may provide the event data as an input to user identity engine 136, which perform operations that generate an account for the user within marketplace platform system 120, and that generate account data identifying and characterizing that newly generated account and profile data characterizing the user.

The profile data may, for example, include information that identifies the user (e.g., the user's name), the user's street or shipping address, payment information that identifies and characterize a payment instrument available for purchases via any of the exemplary processes described herein, and demographic data characterizing the user, such as the user's age, gender, of occupation. In some instances, the profile data may also identify and characterize one or more user-specific preferences for types or genres of video games and gaming applications (e.g., role-playing games, etc.), or for types or brands of products or services offered for sale through the marketplace described herein (e.g., particular brands of shoes, shoe sizes, etc.). User identity engine 136 may store the profile data and corresponding account data in data warehouse 116.

In some examples, executed AI engine 130 may perform operations that, among other things, select product advertisements appropriate to a particular user based on locally maintained profile data characterizing that user and on additional elements of event data characterizing that user's interaction with an executed application program, such as a video game accessed via an executed gaming application or web browser. For instance, executed AI engine 130 may perform operations that select product advertisements appropriate to the particular user based on an application of one or more rules to selected elements of the profile and/or event data. For example, the applied rules may include, but are not limited to: (i) an age-specific rule, which targets advertisements associated with particular age-specific types of products or services to the particular customer (e.g., certain types of shoes for customers between the ages of fifteen and eighteen, and other types of shoes for customer between the ages of twenty-one and twenty-five, etc.); (ii) a preference-specific rule that selects advertisements associated with the customer's specified preferences (e.g., as specified within the profile data); or (iii) an application- or game-specific rule, which selects advertisements based on the type of application program or gaming program that integrates the SDK, or a specific video game with which the customer interacts.

In other examples, executed AI engine 130 may select appropriate advertisements for the particular customer based on an application of a trained machine learning (ML) or artificial intelligence (AI) model to a dynamically determined set of input data (e.g., as selected via feature engineering, etc.). Examples of the ML or AI models may include, but are not limited to, a deep neural network and one or more decision tree models, such as a boosted decision tree model. Further, the set of input data may include, but is not limited to: one or more elements of the profile data characterizing the particular customer; one or more elements of the event data; historical interaction data (e.g., as maintained within data warehouse 116) characterizing prior interactions between the particular customer and the marketplace (e.g., data indicating previous activity with the marketplace, such as historical impressions or purchases); application or game data (e.g., rules or requirements game developers configure when adding a game to the marketplace network); and retailer data (e.g., rules or requirements retailers configure when adding a product to the marketplace network). For example, executed AI engine 130 may determine one or more product advertisements for a particular customer based on profile data for that customer, the game data for the game the user is currently playing, and retailer data for a plurality of products.

In some instances, executed recommendation engine 124 may receive requests for the appropriate advertisements from customer computing devices 110A, 110B, and 110C (e.g., as generated by an application program or gaming application integrating the SDK), and may route the received requests to executed AI engine 130, which may perform any of the exemplary processes described herein to select the requested advertisements, and to provide data characterizing these appropriate advertisements (e.g., digital images, digital videos, other elements of digital content, and layout data characterizing a positioning of each of the digital images, digital videos, or other elements of digital content within the GUI, etc.) as a response to executed recommendation engine 124. Further, data characterizing the appropriate advertisements may also be routed to executed event service engine 132, which may store the data within a portion of data warehouse 116 in conjunction with corresponding elements of profile data, e.g., as further information characterizing that customer's interaction with the marketplace.

Further, executed recommendation engine 124 may also transmit the data characterizing the appropriate advertisements across network 118 to a corresponding one of customer computing devices 110A, 110B, or 110C, and the executed application program or gaming application may process the data and present the advertisements within one or more display screens of the marketplace GUI, e.g., within the digital interface associated with the executed application program or gaming application. In some examples, the presented advertisements may facilitate the purchase of the advertised product. For example, a user may engage (e.g., click on, select, etc.) a particular one of the product advertisement, which may cause the executed application program or gaming application (e.g., via the integrated SDK) to add a selected product to an online shopping cart within the executed application program or gaming application. The user may then proceed to purchase the advertised product without ever leaving the environment of the executed application program or gaming application (e.g., the gaming environment of the corresponding game).

When a user purchases a product, the executed application program or gaming application (e.g., via the integrated SDK) may generate and transmit event data characterizing the initiated purchase across network 118 to marketplace platform system 120. In some instances, the API of marketplace platform system 120 may receive the event data, and route the event data to executed event service engine 132 may receive event data identifying and characterizing the purchase. For example, the event data may identify one or more of the user (e.g., login credentials), the game or application program (e.g., a game identification (ID) unique to the game, etc.), the purchased product, the purchase price of the product, and the purchased quantity, along with any selected shipping options. Event service engine 132 may provide this event data to executed commerce services engine 128, which may perform further operations that process and complete the purchase transaction.

For example, executed commerce services engine 128 may perform operations that parse the event data to identify the user (e.g., via the login credentials), and obtain profile data identifying one or more payment instruments available to fund the initiated purchase and shipping information (e.g., an address, etc.) for products purchased through the marketplace. Based on the data identifying the payment instrument, executed commerce services engine 128 may perform operations that generate a payment request that identifies the purchase amount and the payment instrument, and route that payment request to an appropriate payment network or rail (e.g., credit card payment network or debit card payment network) or to a third-party vendor that processes payment (e.g., not illustrated in FIG. 1).

Further, in response to an approval of the payment request, executed commerce services engine 128 may also perform operations that route payment for the purchased product to a corresponding retailer (e.g., the retailer that provided the corresponding product advertisement for the product to the marketplace), either directly or via the third-party vendor described above. Executed commerce services engine 128 may also generate a communication (e.g., email, short message service (SMS) message, etc.) to a device of the corresponding retailer associated with the product (e.g., via retailer computing devices 112A or 112B). The communication may, for example, identify the purchased product, the quantity of the purchase product, the customer name and shipping address, and a confirmation of the approved payment, and upon receipt of the communication, the device of the corresponding retailer may perform operations that complete the purchase and provide the purchased product to the customer.

Additionally, and in further response to an approval of the payment request, executed commerce services engine 128 may perform further operations that allocate marketplace credits to the user based on the purchased products. For example, each advertised product may be associated with a number of marketplace credits. If the user purchases the advertised product, the user is awarded with the number of marketplace credits. In one example, the marketplace credits are cash credits. In other examples, the marketplace credits may be provided as cryptocurrency, which may be utilized on one or more application programs or gaming applications that integrate the SDK and are associated with the marketplace. The user may, for instance, view the marketplace credits associated with the user within the gaming environment, such as within the marketplace GUI presented upon engagement with the marketplace icon.

A user may, in some examples, exchange marketplace credits for in-game points or rewards. For example, a user may initiate an exchange of marketplace credits for in-game points for a particular game, e.g., based on input provided to the marketplace GUI generated and presented at a corresponding one of customer computing devices 110A, 110B, or 110C. Marketplace platform system 120 may receive event data characterizing the requested exchange (e.g., as generated by the application program or gaming application executed at the corresponding one of customer computing devices 110A, 110B, or 110C) via the API, which may route the event data to executed event service engine 132. As described herein, executed event service engine 132 may perform operations that store the received event data within a corresponding portion of data warehouse 116, e.g., in conjunction with the elements of profile data characterizing the user.

Further, the API may also route the received the event data to event commerce services engine 128, which may process the exchange by withdrawing one or more units of marketplace credits from the user's account (e.g., as specified within account data maintained on behalf of the user within data warehouse 166) and by generating a message identifying and characterizing the in-game points to be awarded to the user in exchange for the units of marketplace credits. In some instances, marketplace platform system 120 may transmit the message to a corresponding one of content provider computing devices 114A or 114B, which may process the message and apply the in-game credits for use by the user within the corresponding application program or gaming application (e.g., for in-game purchases within the gaming environment established by the gaming application).

Marketplace dashboard engine 126, when executed by marketplace computing device 102, provides an interface to a marketplace platform, which may be a website hosted by marketplace computing device 102. The marketplace platform may provide an interface to retailer computing systems 112A and 112B, e.g., through which retailers can provide retailer data identifying and characterizing one or more products or services available for purchase within the exemplary marketplace described herein. In some instances, the retailer data may further include requirements (e.g., rules) as to the types of games the products may be advertised within. The marketplace platform further provides an interface to content provider computing systems 114A and 114B, e.g., through which the corresponding content providers, such as game developers, may provide data identifying and characterizing corresponding gaming application and gaming environments. For instance, the elements of gaming data may include information characterizing one or more gaming that integrate the SDK, as well as requirements (e.g., rules) as to which products may be advertised to users of each gaming application. The disclosed embodiments are, however, not limited to gaming applications, and in other instances, content provider computing systems 114A and 114B may provide, through the interface, application data characterizing one or more additional, or alternate, application programs that integrate the SDK, and one or more requirements regarding which products may be advertised within corresponding ones of these application programs.

Executed marketplace dashboard engine 126 may also provide the marketplace platform to administrators of marketplace platform system 120. The marketplace platform may allow administrators to view user data, retailer data, and game data, for example. The marketplace platform may also allow administrators to configure rules used for matching product advertisements to games, or for configuring AI engine 130 (e.g., such as by enabling or disabling machine learning processes, adjusting parameters such as hyper parameters, etc.).

Product management engine 134 may, upon executed by marketplace computing device 102, determine what product advertisements may be displayed within games based on the requirements defined for each product within retailer data and requirements defined for each gaming application within the gaming data (or for each application program within the application data). For each gaming application or application program, product management engine 134 may determine a set of candidate product advertisements that may be displayed. For example, the gaming data may specify that product advertisements for only a particular brand may be displayed with a particular gaming application. As such, executed product management engine 134 may identify all product advertisements associated with that particular brand, and includes the identified product advertisements within a set of candidate product advertisements for that gaming application. The set of candidate product advertisements for each gaming application, and for each application program, may be stored in data warehouse 116, for example. In other examples, the set of candidate product advertisements may be established through an application of one or more of the trained ML or AI models described herein to elements of the retailer data, the gaming data, and/or the application data.

In some examples, executed external services engine 138 may perform operations that facilitate vendor-specific integrations with marketplace platform system 120, such as, but not limited to, integrations with vendor e-commerce systems (e.g., retailer websites or backend systems), shipping systems, external partner services, and external AI services. For example, in some embodiments, rather than matching product advertisements to a user using AI engine 130, external services engine 138 may be operable to communicate with an external AI service that allows for execution of one or more of the trained ML or AI models described herein. In some instances, executed external services engine 138 may generate a message identifying one or more of the user data, the retailer data, and the gaming and/or application data, and may transmits the message to the one or more computing systems associated with the external AI service. In response, the external AI service determines one or more product advertisements, and transmits a message identifying the product advertisements to marketplace platform system 120 via external services engine 138.

In some examples, as described herein, marketplace platform system 120, which includes marketplace computing device 102, instruction memory 140, and data warehouse 116, may correspond to a single, discrete computing system operating within environment 100. In other instances, the functionalities of marketplace platform system 120 may be performed by a combination of discrete computing systems operating within environment 100. Further, in some instances, marketplace platform system 120 may correspond to a distributed system that includes computing components distributed across one or more networks, such as network 118, or other networks, such as those provided or maintained by cloud-service providers (e.g., Google Cloud™, Microsoft Azure™, etc.).

Examples of marketplace computing device 102 of marketplace platform system 120 may include, but are not limited to, a personal computer, a laptop computer, a tablet computer, a notebook computer, a hand-held computer, a personal digital assistant, a mobile phone, a smartphone, a server (e.g., a cloud-based server), and any other type of computing device that may be configured to store data and software instructions and to execute the software instructions to perform operations consistent with disclosed embodiments. Further, examples of customer computing devices 110A, 110B, and 110C may include, but are not limited to, fully-functional desktops computers, handheld or tablet computers, smartphones, or gaming consoles. Further, examples of retailer computing systems 112A and 112B, and content provider computing systems 114A and 114B, may include, but are not limited to, fully-functional desktops computers, handheld or tablet computers, and smartphones.

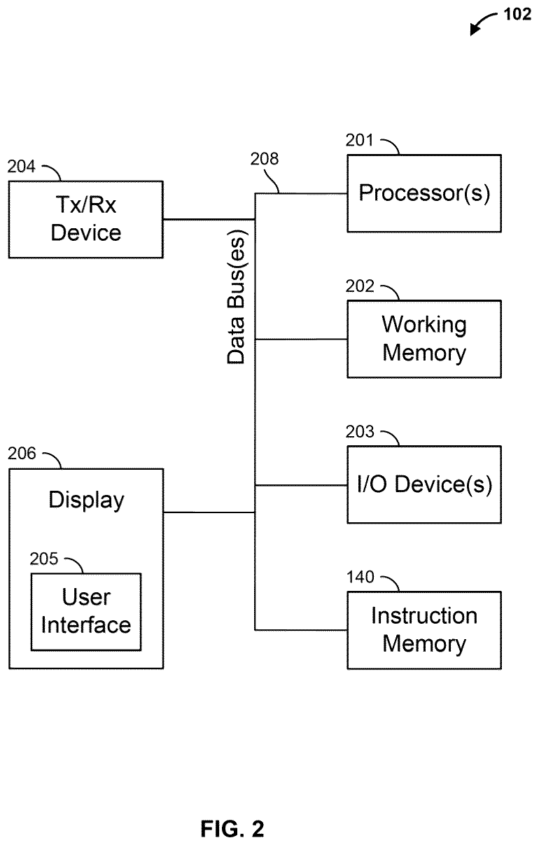

FIG. 2 illustrates an exemplary computing device or system, such a marketplace platform system 120, consistent with certain disclosed embodiments. Further, although not illustrated in FIG. 2, customer computing devices 110A, 110B, and 110C, retailer computing systems 112A and 112B, and content provider computing devices 114A and 114 may include similar hardware components and may perform functionalities similar to those described in reference to marketplace computing device 102.

As illustrated in FIG. 2, marketplace platform system 120 may include one or more processors 201, working memory 202, one or more input/output devices 203, instruction memory 140, a transceiver 204 (e.g., communications unit), and a display 206, all operatively coupled to one or more data buses 208. Data buses 208 allow for communication among the various devices. Data buses 208 may include one or more wired, or wireless, communication channels.

Processors 201 can include one or more distinct processors, each having one or more cores. Each of the distinct processors can have the same or different structure. Processors 201 can include one or more central processing units (CPUs), one or more graphics processing units (GPUs), application specific integrated circuits (ASICs), digital signal processors (DSPs), and the like.

Instruction memory 140 can store instructions that can be accessed (e.g., read) and executed by processors 201. For example, instruction memory 140 can be a non-transitory, computer-readable storage medium such as a read-only memory (ROM), an electrically erasable programmable read-only memory (EEPROM), flash memory, a removable disk, CD-ROM, any non-volatile memory, or any other suitable memory. Processors 201 can be configured to perform a certain function or operation by executing code, stored on instruction memory 140, embodying the function or operation. For example, processors 201 can be configured to execute code stored in instruction memory 140 to perform one or more of any of the functions, methods, or operations disclosed herein, such as those described herein with respect to SDK engine 122, recommendation engine 124, marketplace dashboard engine 126, commerce services engine 128, AI engine 130, event service engine 132, product management engine 134, user identity engine 136, and external services engine 138.

Additionally, processors 201 can store data to, and read data from, working memory 202. For example, processors 201 can store a working set of instructions to working memory 202, such as instructions loaded from instruction memory 140. Processors 201 can also use working memory 202 to store dynamic data created during the operation of marketplace computing device 102. Working memory 202 can be a random access memory (RAM) such as a static random access memory (SRAM) or dynamic random access memory (DRAM), or any other suitable memory.

Input/output devices 203 can include any suitable device that allows for data input or output. For example, input/output devices 203 can include one or more of a keyboard, a touchpad, a mouse, a stylus, a touchscreen, a physical button, a speaker, a microphone, or any other suitable input or output device.

Display 206 can display user interface 205. User interface 205 can enable user interaction with marketplace computing device 102. For example, user interface 205 can be a user interface for an application that allows an administrator to configure the marketplace dashboard. In some examples, a user can interact with user interface 205 by engaging input/output devices 203. For example, a user may provide input via input/output devices 203 response to interface elements presented through display 206. In some examples, display 206 can be a touchscreen, where user interface 205 is displayed on the touchscreen.

Transceiver 204 allows for communication with a network, such as the communications network 118 of FIG. 1. For example, if communications network 118 of FIG. 1 is a cellular network, transceiver 204 is configured to allow communications with the cellular network. Processor(s) 201 is operable to receive data from, or send data to, a network, such as communications network 118 of FIG. 1, via transceiver 204.

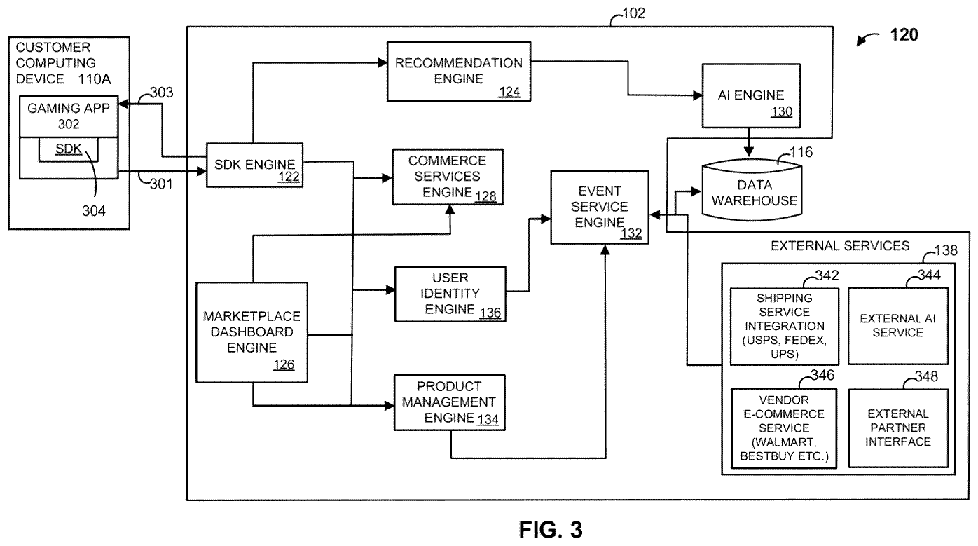

FIG. 3 is a diagram illustrating exemplary portions of computing environment 100, consistent with certain disclosed embodiments. As described herein, SDK engine 122 of marketplace platform system 120 may provide an interface, such as a communication endpoint (e.g., HTTP endpoint) or programmatic interface (e.g., an application programming interface (API) through which executed application programs or executed gaming applications that integrate the SDK may exchange data with marketplace platform system 120 and as such, with the exemplary electronic marketplace platform described herein.

As illustrated in FIG. 3, customer computing device 110A may execute a gaming application 302, which integrates an SDK associated with and provisioned by marketplace platform system 120, such as SDK 304. In some instances, executed SDK engine 122 may perform any of the exemplary processes described herein to provision elements of digital content (e.g., icons, interface elements, visual components) to executed gaming application 302 that are suitable for display within the context of the gaming environment provided by executed gaming application 302. For example, the provisioned elements of digital content may represent portions of the gaming environment itself, e.g., as a portion of streaming gaming environment. In other examples, the elements of digital content may facilitate the presentation of one or more dynamically selected advertisements as part of a marketplace GUI within an on-going gaming environment.

Additionally, SDK engine 122 may receive certain elements of event data 301 from executed gaming application 302, and may perform operations that parse the received elements of event data 301 for further distribution to other software engines executed by marketplace platform system 120, such as those described above in reference to FIG. 1. For example, executed SDK engine 122 may route event data 301 to executed user identity engine 136, which may perform any of the exemplary processes described herein to authenticate an identity of a corresponding user based on copies of locally stored login and authentication credentials (e.g., as maintained within data warehouse 116), and additionally, or alternatively, when a marketplace account does not exist exists for the user, provide additional data to executed gaming application 302 that, when presented to the user, prompts the user to create a marketplace account.

Further, and responsive to a successful user authentication, SDK engine 122 may obtain from executed recommendation engine 124 product advertisements appropriate for display to the now-authenticated user within the gaming environment established by executed gaming application 302. For example, event data 301 may include a request for advertising content, and as described herein, executed recommendation engine 124 may generate and transmit programmatic instructions to executed AI engine 130, which may cause executed AI engine 130 to perform any of the exemplary processes described herein to select product advertisements appropriate to the user and the gaming environment.

For example, and as described herein, executed AI engine 130 may select appropriate advertisements for the particular customer based on an application of a trained ML or AI model to a dynamically determined set of input data (e.g., as selected via feature engineering, etc.). Examples of the ML or AI models may include, but are not limited to, a deep neural network and one or more decision tree models, such as a boosted decision tree model. Further, the set of input data may include, but is not limited to: one or more elements of the profile data characterizing the user, one or more elements of event data 301, historical interaction data (e.g., as maintained within data warehouse 116) characterizing prior interactions between the user and the marketplace (e.g., data indicating previous activity with the marketplace, such as historical impressions or purchases), gaming data (e.g., rules or requirements game developers configure when adding a game to the marketplace network), and retailer data (e.g., rules or requirements retailers configure when adding a product to the marketplace network). Executed recommendation engine 124 may receive the selected advertisements from executed AI engine 130, and may provide data 303 that characterizes the selected advertisements to SDK engine 122 for transmission (e.g., via transceiver 204) to customer computing device 110A. In some instances, executed gaming application 302 may process and ingest data 302, and may perform any of the exemplary processes described herein to present the selected advertisements to the user within the gaming environment, e.g., on one or more display screens of the marketplace GUI upon selection of the marketplace icon.

In some examples, AI engine 130 trains the one or more machine learning processes with training data (e.g., unsupervised training data), which may include historical user data, historical retailer data, and historical game data. For example, AI engine 130 may train the one or more machine learning processes with training data covering a first period of time (e.g., 12 months, 16 months). Once trained, the one or more machine learning processes may be validated (e.g., tested) with validation data covering a second period of time (e.g., 2 months, 4 months). The one or more machine learning processes may be refined during the validation. Once validated, the one or more machine learning processes may made available for use to determine product advertisements for users.

In some examples, executed recommendation engine 124 and executed AI engine 130 may perform any of the exemplary processes described herein to select advertising content appropriate to the user and to the gaming environment on accordance with a predetermined schedule (e.g., nightly, weekly, monthly, or at specified dates, which may be configurable and stored within data warehouse 116), or in response to a detection of a specific triggering event. Executed recommendation engine 124 may, for example, store data identifying and characterizing the selected advertisements and advertising content for each registered user of marketplace platform system 120 (e.g., for each user having a registered account) within data warehouse 116, e.g., in conjunction with corresponding elements of profile data. When a request for advertising content appropriate to a particular user and/or gaming environment is received from SDK engine 122, executed recommendation engine 124 may access data warehouse 116 and obtain all or a selected subset of the stored advertisements and advertising content associated with that particular user, and transmit data 303 that includes the obtained advertisements or advertising content to SDK engine 122, e.g., for transmission (e.g., via transceiver 204) to customer computing device 110A.

In other instances, event data 301 may also identify and characterize user activity related to the marketplace within the gaming environment. Examples of this marketplace activity include, for example, activating the marketplace interface (e.g., by engaging a marketplace icon), viewing a particular product (e.g., an impression), purchasing a product, logging in to the marketplace, logging out of the marketplace, and progress made by the user in game play. Based on the marketplace activity, SDK engine 122 may provide event data 301 to event service engine 132, which may log the receipt of event data 301 within a corresponding event log (e.g., maintained within data warehouse 116), and may store event data 301 within a portion of data warehouse 116, e.g., in conjunction with corresponding elements of profile data characterizing that user. As described herein, AI engine 130 may then obtain all or a portion of event data 301 from data warehouse 166, e.g., for input into the adaptively trained ML and AI models described herein.

In some instances, product management engine 134 may filter out ineligible products from being advertised within a particular gaming environment, e.g., as established by executed gaming application 302. For example, event service engine 132 may receive event data 301 identifying a request for advertisements appropriate to a particular user of executed gaming application 302. In response to a request from event service engine 132, product management engine 134 may perform any of the exemplary processes described herein to identify a set of candidate product advertisements appropriate to the user and the gaming environment based on based on requirements set forth within locally maintained elements of retailer data, e.g., as maintained within data warehouse 116. For example, product management engine 134 may include a product advertisement in the set of candidate product advertisements if none of the rules would be violated if the product advertisement were to be displayed within the game. Product management engine 134 may provide the set of candidate product advertisements for each game to event service engine 132 for storage into data warehouse 116.

In additional examples, product management engine 134 may, in accordance with a predetermined schedule (e.g., nightly, weekly, monthly, etc.), perform any of these exemplary processes described herein to generate a set of candidate product advertisements for gaming application 302 and other gaming applications that integrate the SDK (and further, for any additional or alternate application programs that integrate the SDK), and to stores the generated sets of candidate product advertisements in data warehouse 116. Event service engine 132 may then obtain the set of candidate product advertisements for a particular gaming environment, such as that established by gaming application 302, from data warehouse 116. Additionally, in some examples, and when selecting product advertisements appropriate to a user and a gaming environment (e.g., the user interacting with executed gaming application 302, etc.), AI engine 130 may operate on the corresponding set of candidate product advertisements for that gaming environment and user, which excludes product advertisements outside of that candidate set from display to user within the gaming environment.

As described herein, marketplace dashboard engine 126 may perform operations that provide an interface, such as a webpage, to the marketplace platform. The provisioned interface may, for example, allow retailers, via retailer computing systems 112A and 112B, to provide retailer data to marketplace platform system 120, and examples of the retailer data include, but are not limited to, information about a product, such as a product description, product options (e.g., colors), product features, and/or a product price. The retailer data may further include requirements as to the types (e.g., categories) of games within which each of the identified products may be advertised.

Further, the retailer data may also identify one or more rewards provisionable to the user in response to a purchase of a particular product. The reward may be a monetary award (e.g., a cash back reward) or an award of a specified number of units of cryptocurrency or marketplace credits, for the user making the purchase. In some examples, marketplace dashboard engine 126 may provide the reward to commerce services engine 128 and, in response, commerce services engine 128 determines a corresponding number of marketplace credits to award to the user. For example, the number of marketplace credits may have a value equal to the reward based on a predetermined conversion ratio (e.g., 1000 marketplace credits for each reward dollar). Commerce services engine 128 may update user data for the user stored in data warehouse 116 with the marketplace credits, which as described herein the user may exchange for in-game rewards or credits of any game part of the marketplace network (e.g., from within the game environment of any game).

The provisioned interface may also allow content providers, such as game developers via content provider computing devices 114A, 114B, to provide gaming data to marketplace platform system 120. Examples of the gaming data may include information about the gaming application that integrate the SDK, such as game ratings (e.g., age ratings, violence ratings, etc.), and, in some examples, requirements as to which products may be advertised to users of each game. For example, a content provider may specify that products of a particular category (e.g., grocery items) not be advertised to users of a particular gaming application. Marketplace dashboard engine 126 may store the received retailer data and gaming data within data warehouse 116.

In some examples, marketplace dashboard engine 126 may also perform operations that generate analytical information characterizing the products or services offered for sale through the exemplary marketplace GUI described herein, and that display the generated analytical information within the interfaces provisioned to retailer computing systems 112A and 112B and/or to content provider computing systems 114A and 114B. For example, marketplace dashboard engine 126 may aggregate and display products sold, total purchase amounts, times of sales, campaign performance measures, promotion engagement by users (e.g., a percentage of users that accept the promotion), conversions to buy (e.g., a percentage of users that buy the product after clicking on the product advertisement), and demographic information of the purchasers sold through all games. In some examples, marketplace dashboard engine 126 may provide similar information, but on a per game basis (e.g., for each game).

External services engine 138 may perform operations that facilitate vendor-specific integration of external services with marketplace platform system 120. In some examples, external services engine 138 includes shipping service integration module 342, external AI services module 344, vendor e-commerce service module 346, and external partner interface module 348. Further, each of shipping service integration module 342, external AI services module 344, vendor e-commerce service module 346, and external partner interface module 348 may, upon execution, establish a secure, programmatic channel of communications with one or more devices or computing systems of respective external services. Event service engine 132 may communicate with external services engine 138 to facilitate and support the integration, access, and provisioning of these external services.

For example, external AI services module 344 may establish a programmatic interface to a computing system of a third-party vendor that provides ML or AI services, such as ML models that may be employed by AI engine 130. In some examples, external services engine 138 may perform operations that, via the programmatic communications channel established by external AI services module 344, obtain one or more ML models, such as deep neural network algorithms or boosted decision tree algorithms, and store the obtained ML models in data warehouse 116. AI engine 130 may then obtain the machine learning models from data warehouse 116, and train, or execute, the machine learning models, e.g., using any of the exemplary processes described herein.

In some examples, event service engine 132 may, based on interaction with shipping service integration module 342, obtain data identifying and characterizing shipping options and corresponding costs for shipping products purchased the user of executed gaming application 302 using any of the exemplary processes described herein. For example, event service engine 132 may provide shipping request data corresponding to a product to shipping service integration module 342 and, in response, obtain one or more shipping options for the product from one or more computing systems associated with various shipping services, such as Federal Express™ or UPS™. The shipping request data may identify a product, an origin address, a destination address, and a weight of the product, for example.

In some examples, and as described further herein, a retailer may configure a shipping setting within the marketplace platform (as facilitated by marketplace dashboard engine 126) that enables the obtaining of shipping costs for a product. When enabled, event service engine 132 may automatically obtain shipping costs from shipping service integration module 342 when a product advertisement for the product is to be displayed to a user. For example, recommendation engine 124 may select a product advertisement appropriate for display to a user of executed gaming application 302, and assuming the shipping setting is enabled, event service engine 132 may obtain an address for the user from user data stored within data warehouse 116, and may generate shipping data that includes the address as the destination address, as well as an origin address of the retailer and a weight of the product, each of which may be stored within retailer data in data warehouse 116. Event service engine 132 may provide the shipping data to shipping service integration module 342 and, in response, obtain shipping response data identifying one or more shipping options. For example, the shipping response data may identify a first cost for shipping the product with a first carrier, and a second cost for shipping the product with a second carrier. In some examples, the shipping response data further identifies an estimated day of delivery.

Vendor e-commerce service module 346 may provide secure, programmatic channels of communication to respective vendors, such as retailer websites, and external partner interface module 348 may similarly provide secure, programmatic channels of channels to computing systems or devices associated with other partners or third-party services. In some instances, vendor e-commerce service module 346 may obtain, from external computing systems via the programmatic communications channels, product descriptions and product pricing for product advertisements determined by recommendation engine 124.

For example, rather than a retailer configuring a price for a product within the marketplace platform (as facilitated by marketplace dashboard engine 126), the retailer may configure the marketplace platform to obtain product data, such as the product description and price, from the retailer's website. In some instances, event service engine 132 may submit a request to external services engine 138 to obtain the product data and, in response, external services engine parses the request, generates a request message in conformance with a pre-established protocol of communication with vendor e-commerce service module 346, and transmits the request message via vendor e-commerce service module 346 to one or more computing external systems. External services engine 138 may then obtain from vendor e-commerce service module 346 a response message that identifies the requested product data, such as a product description and price. External services engine 138 parses the response message, and provides the product data to event service engine 132 for inclusion, for example, into a product advertisement to be displayed to the user of executed gaming application 302.

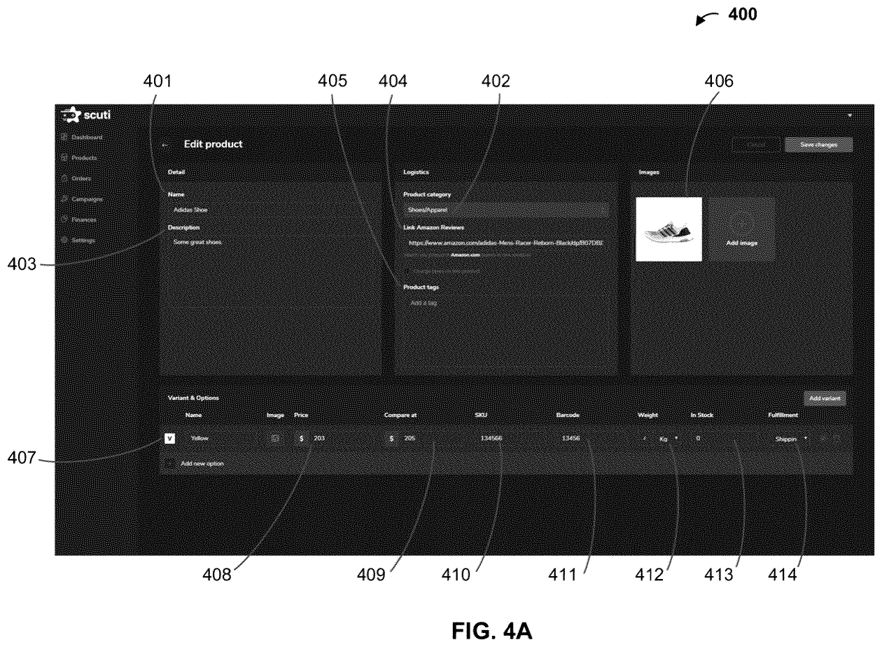

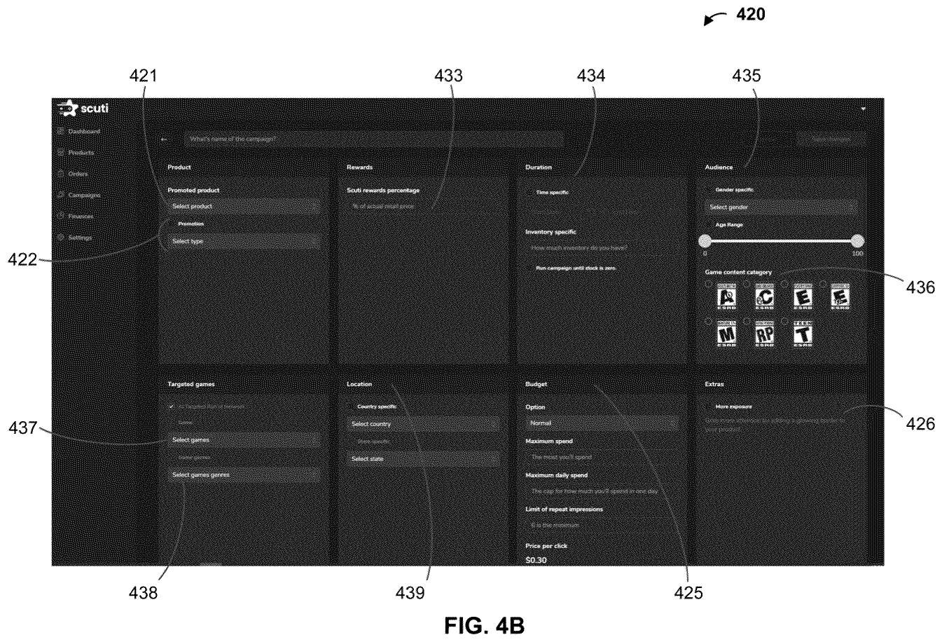

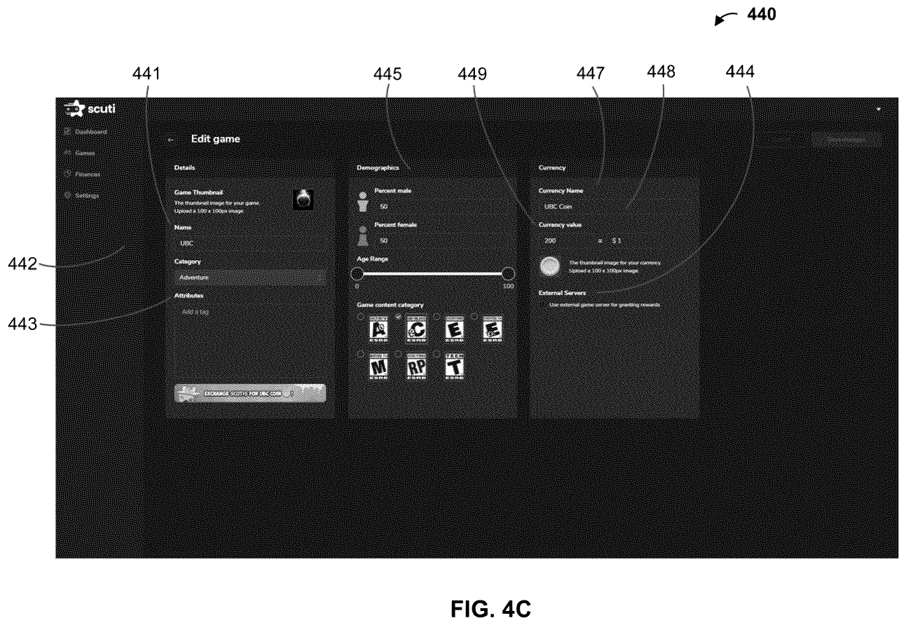

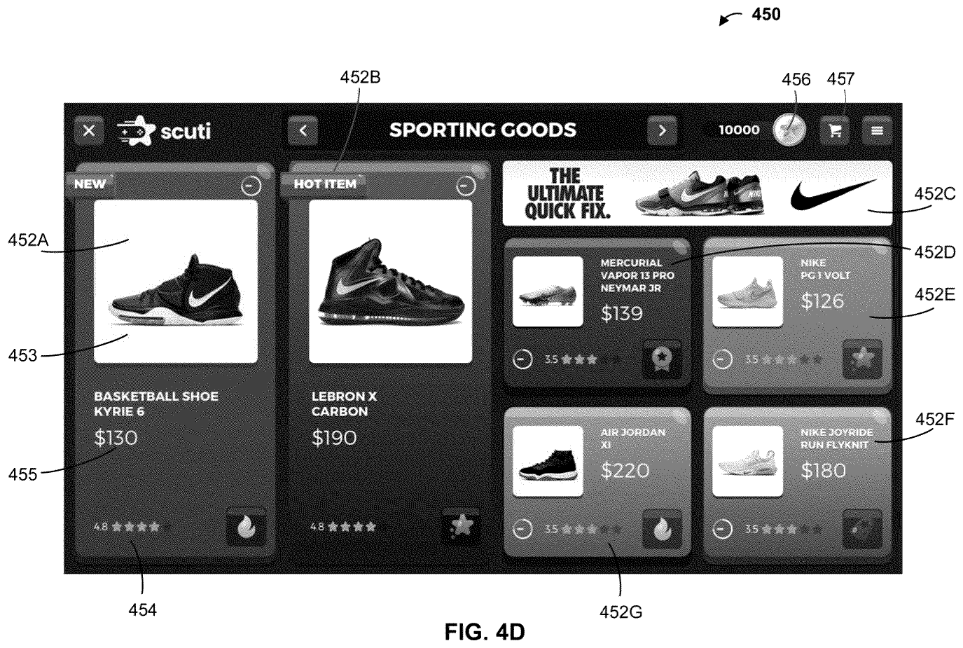

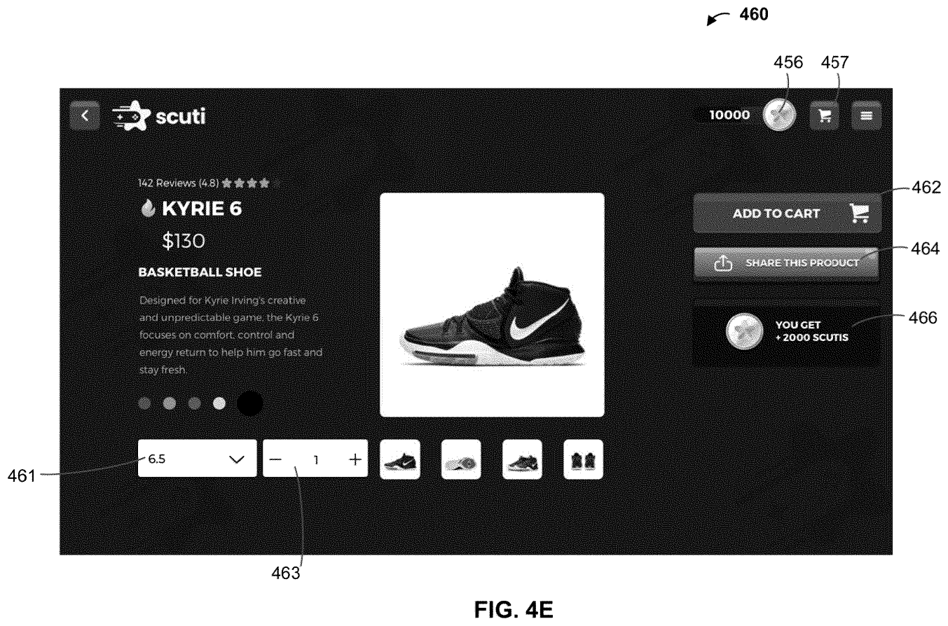

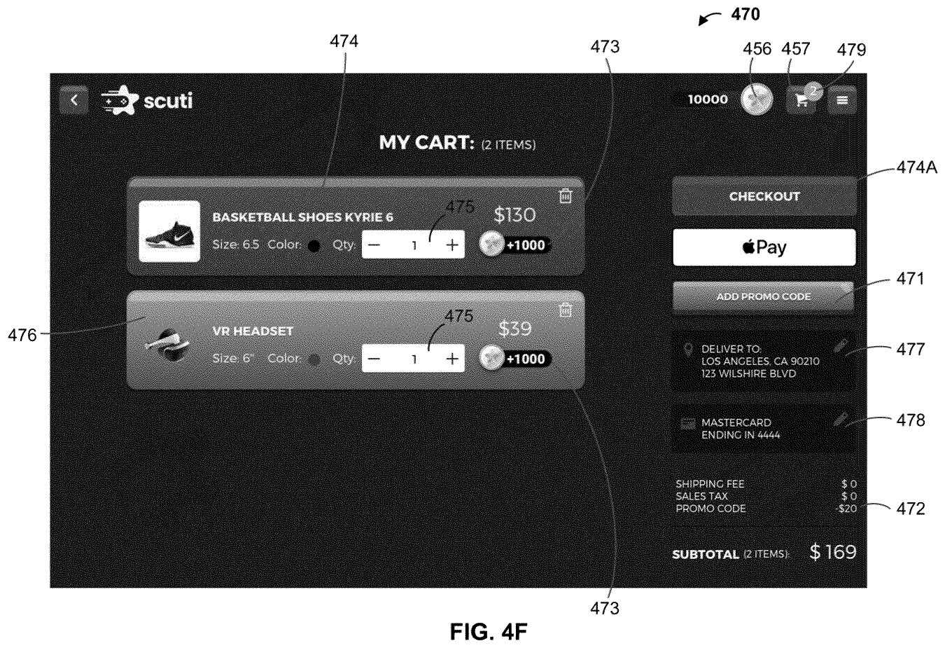

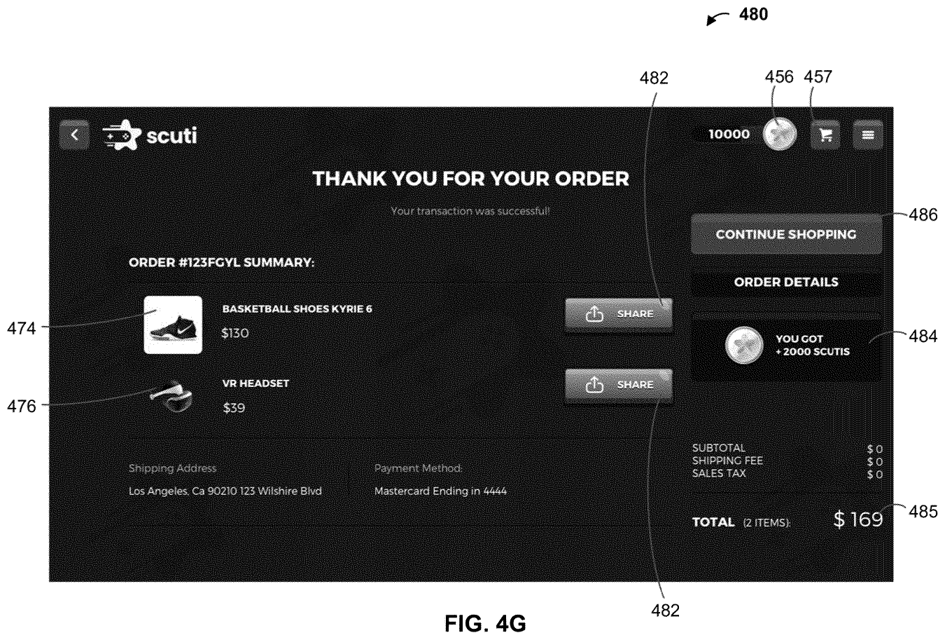

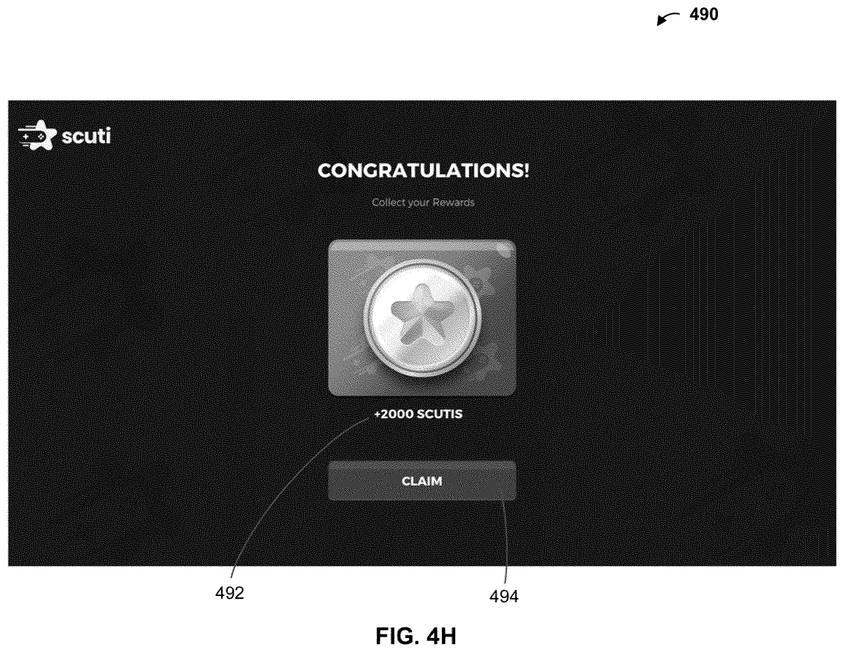

FIGS. 4A and 4B illustrate respective ones of exemplary graphical user interfaces (GUIs) 400 and 420, consistent with certain disclosed embodiments. In some instances, each of GUIs 400 and 420 may correspond to a web page accessible at one or more of retailer computing devices 112A or 112B via an executed web browser.

GUI 400 may include interface elements that enable a retailer to modify (e.g., add, delete, etc.) a list of products available for inclusion within advertisements targeted to users of a gaming application or application program by marketplace platform system 120. As illustrated in FIG. 4A, the interface elements of GUI 400 allow for the entry of a product name 401, product description 403, product category 402, a hyperlink to product reviews 404, product tags 405 (e.g., attributes), and one or more product images 406. GUI 400 also includes interface elements to allow the retailer to provide option data 407 (e.g., color information) for the product, as well as a product price 408, a comparison price 409, a product identifier 410 (e.g., SKU number), a barcode number 411, and a product weight 412 (e.g., to automatically determine shipping costs, as described herein). Further, GUI 400 includes interface elements to allow the retailer to provide an inventory amount 413 (e.g., a number of products available for sale for this product advertisement) and fulfillment data 414 (e.g., shipping, on back order, etc.).

Referring to FIG. 4B, GUI 420 may include interface elements that prompt a retailer to associate products (e.g., such as products added via GUI 400) to a particular advertising campaign, and to provide reward information and requirement data for the associated products. The requirement data may, for example, include requirements (e.g., rules) as to which games the product advertisement may be provided to (e.g., as determined by product management engine 134). As illustrated in FIG. 4B, GUI 420 provides interface elements to allow a retailer to select the product 421 (e.g., by the product name 401 specified in GUI 400), and to assign a promotion 422 to the product. The retailer may further specify a reward amount 433, which may be based on a percentage of the sales price of the product. In some examples, commerce services engine 128 converts the amount of the reward to marketplace credits based on a predetermined convergence ratio. The retailer may further specify duration data 434 for the campaign, which may be based on a specific period of time, or based on inventory.

GUI 420 may also include interface elements that prompt the retailer to provide requirement data. For example, the retailer may specify requirements for the audience 435 (e.g., the gamers) that may view the product advertisements, such as requirements based on gender and age. The retailer may further specify allowable game content categories 436. For example, games not rated according to one of the selected game content categories may not present the product advertisements to its users.

Further, GUI 420 may include interface elements that allow a retailer to identify one or more games 437 or game genres 438 permitted to display the product advertisement, and further interface elements to prompt the retailer to specify geographic requirements associated with the presentation of the product advertisement, such as country and/or state requirements. The geographic requirements may, for example, identify a geographic region where a user must be playing the game for the product advertisement to be displayed to the user. Through these exemplary processes and GUIs, a retailer may provide varying product advertisements for a same product (e.g., differing prices), where a product advertisement may be displayed to a particular user of the game based on where the user is located (e.g., state-specific advertisements).

GUI 420 also provides interface elements that prompt the retailer to specify budget data 424 (e.g., costs to the retailer) associated with the provisioning of product advertisement to users within a particular gaming environment or within a particular application program. For example, the retailer may specify an upper limit the amount of spend on the product advertisement across the entire campaign or on a daily basis (e.g., a max of $100 per day, for a maximum overall cost of $10,000), and may also characterize the upper limit based on a price per impression (e.g., cost per view) and/or a price per click (e.g., cost per click). GUI 420 also allows the retailer to specify the maximum number of times the product advertisement may be shown to the same user (e.g., maximum impressions). In some examples, GUI 420 provides one or more advertisement options 426 for the retailer to enhance the product advertisement (e.g., such as by adding a glowing boarder to the product advertisement).

FIG. 4C illustrates an exemplary graphical user interface (GUI) 440, consistent with certain disclosed embodiments. In some instances, GUI 440 may correspond to a web page accessible at one or more of content provider computing devices 114A or 114B via an executed web browser. As illustrated in FIG. 4C, GUI 440 includes interface elements that prompt a content provider, such as a game developer, to provide information about one or more gaming applications (or other application programs) that integrate the exemplary SDK described herein.

In some instances, via GUI 440, the content provider to either add a gaming application to the marketplace network, or edit information about a gaming application already in the marketplace network. For example, GUI 440 may allow the content provider to specify details such as a game name 441, a category 442 of the gaming application, and tags 443 for the game and gaming application. GUI 440 may also prompt the content provider to specify demographics information 445 for users of the gaming application, such as the percentage of males and females that pay the game and an age range for the users, as well as a game rating.

Further, GUI 440 may prompt the content provider to provide game currency information 447 for the gaming application, which may include a currency name 448 and a currency value 449. As described herein, a user may wish to convert marketplace credits for in-game credits (via the SDK integrated into the gaming application). When the user wishes to convert marketplace credits for in-game credits of a game, the user may provide a number of (or value of) the marketplace credits to be converted as inputs to executed gaming application 302 of customer computing device 110, which may transmit a message to marketplace computing device 102 requesting the conversion. Marketplace platform system 120 may (e.g., via commerce services engine 128) determine the conversion of marketplace credits to the in-game currency based on the currency value 449, which may specify an exchange ratio of marketplace credits to in-game credits.

For example, assume the user of gaming application 302 requests to exchange 10,000 marketplace credits for in-game credits. Also assume that 1,000 marketplace credits are equivalent to one dollar, and currency value 449 identifies 200 in-game credits are equivalent to one dollar. Marketplace platform system 120 may determine that the user is to be credited with 2000 in-game credits (e.g., (10,000/1000)*200), and may deduct the number of marketplace credits from the user's account (e.g., based on account data maintained within data warehouse 116). Marketplace platform system 120 may generate and transmit a response to executed gaming application 302 that identifies the in-game credits to be awarded to the user, and executed gaming application 302 may credits the user with the in-game credits, e.g., within the established gaming environment. As an alternative, GUI 440 allows a content provider to identify (e.g., via IP address, or HTTP address) an external server 444 to grant in-game rewards to a user.

FIGS. 4D-4H are diagrams of illustrating respective ones of exemplary graphical user interfaces (GUIs) 450, 460, 470, 480, and 490, consistent with certain disclosed embodiments. In some instances, each of GUIs 450, 460, 470, 480, and 490 may correspond to one or more display screen of a marketplace interface or GUI rendered for presentation within a gaming environment, such as that established by executed gaming application 302, in response to user input provided to customer computing device 110A. Further, and as described herein, the each of GUIs 450, 460, 470, 480, and 490 may accessible to the user within the gaming environment, and may obscure all, or a selected portion of, the digital content presented within that gaming environment by executed gaming application 302.

Referring to FIG. 4D, GUI 450 includes multiple product advertisements 452A, 452B, 452C, 452D, 452E, 452F, 452G. For example, one or more of product advertisements 452A-452E may include one or more of a product image 453, a product price 455, and a product review 454. GUI 450 also displays marketplace credit award 466 that are credited to the user, and may further include an online shopping cart icon 457 that, if selected by the user (e.g., based on input provided to customer computing device 110A), displays an online shopping cart that facilitates the purchase of products.

GUI 450 may also include a category filter that allows a user to select, or filter out, a category of products. For example, GUI 450 may allow a user to select one or more product categories (e.g., electronics, clothing, shoes, grocery items, etc.) and, in response, may cause the executed gaming application 302 to generate and transmit a request to marketplace platform system 120 (e.g., via SDK engine 122) for product advertisements associated with products that match the selected product categories. Marketplace platform system 120 may perform any of the exemplary processes described herein to: filter candidate product advertisements appropriate to the user and to gaming application 302 in accordance with the selected product categories; and to transmit the filtered product advertisements to executed gaming application 302, e.g., for display within GUI 450.

In some examples, the user may provide input to customer computing device 110A that selects product advertisement 452, which causes executed gaming application 302 to present an additional GUI, such as GUI 460 of FIG. 4E, that includes additional details of the selected product, such further product description, images, or options. Referring to FIG. 4E, GUI 460 includes an add-to-cart icon 462, and a share icon 464, as well as a marketplace credit award 466 that is credited to the user if the user purchases the product. GUI 460 also presents interface elements that allow the user to select options for the product. In this example, advertising GUI 460 includes a selectable size 461, and a selectable quantity 463, for the product.

In some instances, the user may elect to purchase the product presented, identified, and characterized by GUI 460, and the user provide additional input to customer computing device 110 that selects add-to-cart icon 462 to add the product to the user's online shopping cart. The user may also provide input to customer computing device 110 selecting online shopping cart icon 457, which indicates the user's desire to view the contents of the online shopping cart. Based on the additional provided input, executed gaming application 302 may perform operations that generate and present an additional GUI, such as GUI 470 of FIG. 4F, that identifies and characterizes those products or services in the user's online shopping cart.

Referring to FIG. 4F, GUI 470 specifies that the user's online shopping cart includes a first item 474 (e.g., the product identified within GUI 460 of FIG. 4E) and a second item 476. The user may, for example, provide further input to customer computing device 110A that adjusts a quantity 475 of each item within GUI 470. Further, each of first item 474 and second item 476 may be further associated with marketplace credits 473, and GUI 470 also includes interface elements allowing the user to specify a shipping address (e.g., destination address) 477, billing information 478 (e.g., credit card number, debit card number), a promotion icon 471, and a checkout icon 474A.

If selected by the user (e.g., based on further input provided to customer computing device 110A), promotion icon 471 allows the user to enter a promotion value (e.g., code) that, if accepted and verified (e.g., by the game and/or marketplace platform system 120), applies a discount 472 to the purchase amount. Checkout icon 474A facilitates purchase of the items 474 and/or 476 in the online shopping cart. For example, upon receipt of additional user input selecting checkout icon 474A, executed gaming application 302 may transmit data identifying one or more of purchased items 474 and/or 476, the quantity 475 of each item, the shipping address 477, the billing information 478, and the marketplace credits 473 associated with each purchased item.

In some examples, an indicator 479 may be overlaid over online shopping cart icon 457 indicating how many products are currently held within the online shopping cart, as illustrated in FIG. 4F. The color of indicator 479 may enable the user to visually differentiate indicator 479 from shopping cart icon 457 and to visually perceive the number of items in the online shopping cart.

In some instances, and in response to the user completing the purchase order, executed gaming application 302 may perform operations that generate an additional GUI, such as GUI 480 of FIG. 4G, that presents information identifying and characterizing the now-completed purchase order. Referring to FIG. 4G, GUI 480 may include interface elements that identify purchased items 474 and/or 476, and may include a share icon 482 for each purchased item, which facilitates the generation and dissemination of the product advertisement to others (e.g., via social media, email, SMS, etc.). GUI 480 also includes a total purchase amount 485, and a continue shopping icon 486 that, if selected by the user using any of the exemplary processes described herein, causes executed gaming application 302 to present an additional GUI, such as GUI 450 of FIG. 4D, that include additional product advertisements within the marketplace.

GUI 480 may also include a marketplace credit summary icon 484 identifying a number of marketplace credits awarded to the user in response to the purchase. In some examples, the user may provide additional input to customer computing device 110A that selects redemption icon 456, and based on the additional input, executed gaming application 302 may perform operations that generate an additional GUI, such as GUI 490 of FIG. 4H, that includes interface elements prompting the user to redeem one or more units of marketplace credits.

Referring to FIG. 4H, GUI 480 include interface elements that identify the number 492 of marketplace credits awarded to the user and available for redemption or exchange, and a claim icon 494. In some instances, the user may provide additional input to customer computing device 110A that selects claim icon 494, and based on the additional input, executed gaming application 302 may perform operations that generate and transmit, to marketplace platform system 120 across network 118, a request to redeem or exchange the marketplace credits. Based the received request, marketplace platform system 120 may perform any of the exemplary processes described herein to exchange the credits for in-game credits or rewards for the corresponding game environment (e.g., as established by executed gaming application 302).

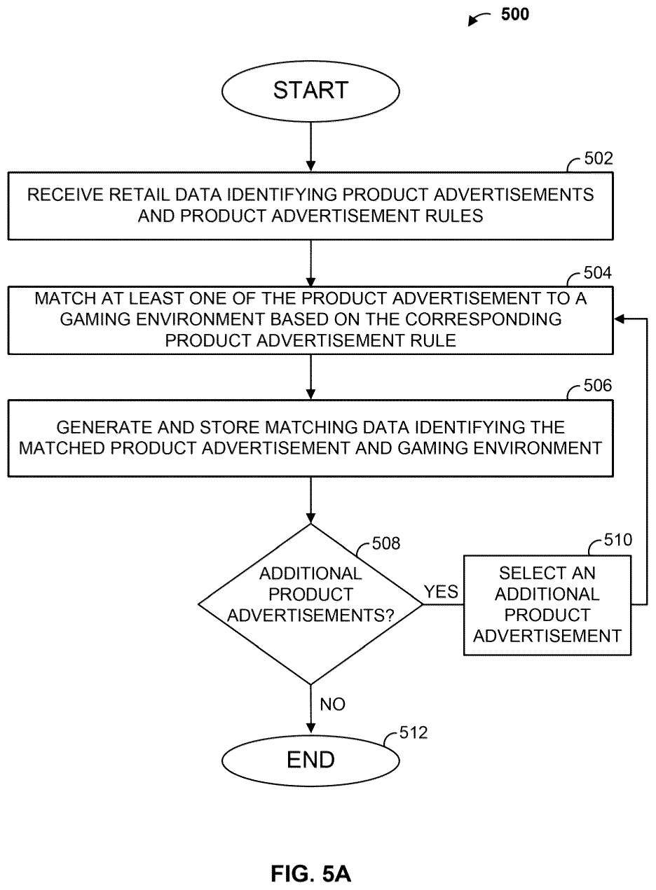

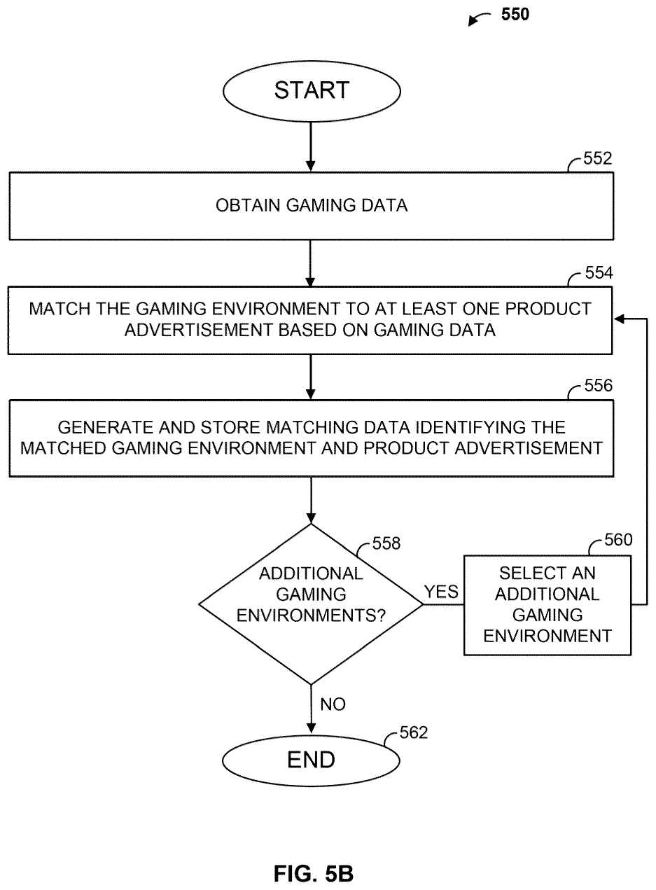

FIG. 5A is a flowchart of an exemplary process 500 selecting one or more elements of advertising content that are appropriate to a particular gaming environment, consistent with certain exemplary embodiments. In some examples, a computing system associated with an electronic marketplace platform within environment 100, such as marketplace platform system 120, may perform one or more of the exemplary steps of process 500.

In some instances, marketplace platform system 120 may perform any of the exemplary processes described herein to receive, obtain, or load retail data that, among other things, identifies one or more product advertisements and one or more rules associated with each of the product advertisement (e.g., in step 502 of FIG. 5A). For example, and as described herein, data warehouse 116 may maintain data identifying and characterizing the one or more product advertisements, and in step 502, marketplace platform system 120 may perform operations that access data warehouse 116 and obtain elements of the maintained data that identify and characterize at least one product advertisement, such as product advertisement 452A of FIG. 4D. Further, and as described herein, the obtained data may also specify at least rule for the product advertisement, such as, but not limited to, a rule specifying one or more genres of games permitted to present the at least one product advertisement, e.g., action, role playing, etc.

Based on one or more product advertisement rules, marketplace platform system 120 may also perform any of the exemplary processes described herein to identify one or more gaming environments, and corresponding gaming applications, having characteristics that are consistent with, or match, the at least one product advertisement rule (e.g., in step 504 of FIG. 5A). For example, marketplace platform system 120 may perform operations that access data warehouse 116, and obtain elements of gaming data that identify and characterize a plurality of candidate gaming environments and corresponding gaming applications. As described herein, the obtained gaming data may identify, among other things, a gaming genre associated with each of the gaming environments and gaming application, and based on the obtained gaming data, marketplace platform system 120 may determine at least one of the gaming environments and corresponding gaming applications having a gaming genre consistent with at least one product advertisements rule.

Marketplace platform system 120 may further generate elements of matching data that associate the at least one product advertisement with each of the matched gaming environments, and gaming applications, and that store the matching data within a data repository, such as data warehouse 116. In some instances, the matching data identifies and characterizes the matched product advertisement(s) and the gaming environment(s) and corresponding gaming application(s). For example, and for a particular product advertisement, the matching data may identify a set of candidate gaming environment(s) and corresponding gaming application(s) that may display the particular product advertisement in accordance with the specific product advertisement rule.

Marketplace platform system 120 may further parse data warehouse 116 to determine whether additional product advertisements require processing (e.g., in step 508 of FIG. 5A), and if product advertisements require processing (e.g., step 508; YES), marketplace platform system 120 may perform any of the exemplary processes described herein to select an additional one of the product advertisements for processing (e.g., in step 510), and exemplary process 500 may pass back to step 504 described herein. Alternatively, if marketplace platform system 120 were to determine that no additional product advertisements require processing (e.g., step 508; NO), exemplary process 500 is then complete in step 512.

FIG. 5B is a flowchart of an additional exemplary process 550 selecting one or more elements of advertising content that are appropriate to a particular gaming environment, consistent with certain exemplary embodiments. In some examples, a computing system associated with an electronic marketplace platform within environment 100, such as marketplace platform system 120, may perform one or more of the exemplary steps of process 550.

In some instances, marketplace platform system 120 may perform any of the exemplary processes described herein to receive, obtain, or load retail gaming data that, among other things, identifies one or more gaming environments and corresponding gaming applications, along with one or more rules associated with each of the gaming environments and corresponding gaming applications (e.g., in step 552 of FIG. 5A). For example, and as described herein, data warehouse 116 may maintain gaming data identifying and characterizing the one or more gaming environments and corresponding gaming applications, and in step 502, marketplace platform system 120 may perform operations that access data warehouse 116 and obtain elements of the maintained gaming data that identify and characterize at least one gaming environment and corresponding gaming application, such as the gaming environment and gaming application associated with name 441 of FIG. 4C. Further, and as described herein, the obtained data may also specify one or more rules for the gaming environment and gaming application (e.g., “gaming” rules), such as, but not limited to, a gaming rule specifying no product advertisements associated a specified product category may be displayed to a user within the gaming environment or by the corresponding gaming application.

Based on one or more gaming rules, marketplace platform system 120 may also perform any of the exemplary processes described herein to identify one or more product advertisements having characteristics that are consistent with, or match, the one or more gaming rules of a selected one of the gaming environments and corresponding gaming applications (e.g., in step 554 of FIG. 5B). For example, marketplace platform system 120 may perform operations that access data warehouse 116, and obtain elements of retail data that identify and characterize a plurality of candidate product advertisements. As described herein, the obtained retail data may include, among other things, a product identifier (e.g., a product name) and a product type or class (e.g., shoes) associated with each of the candidate product advertisements, and based on the obtained product data, marketplace platform system 120 may determine at least one of the product advertisements that is associated with a product type or class and consistent with one or more gaming rules of the selected gaming environment or gaming application (e.g., product advertisement 452A of FIG. 4D).

Marketplace platform system 120 may further generate elements of matching data that associate the selected gaming environment or gaming application with the at least one matched product advertisement, and that store the matching data within a data repository, such as data warehouse 116 (e.g., in step 556 of FIG. 5B). In some instances, the matching data identifies and characterizes the matched product advertisement(s) and the selected gaming environment and corresponding gaming application. For example, and for the selected gaming environment and corresponding gaming application, the matching data may identify a set of candidate product advertisement(s) appropriate for disclose within the selected gaming environment and gaming application with the one or more gaming rules.

Marketplace platform system 120 may further parse data warehouse 116 to determine whether additional gaming environment and gaming applications require processing (e.g., in step 558 of FIG. 5B), and if additional gaming environments and gaming systems require processing (e.g., step 558; YES), marketplace platform system 120 may perform any of the exemplary processes described herein to select an additional one of the gaming environments and gaming systems for processing (e.g., in step S560 of FIG. 5B), and exemplary process 560 may pass back to step 554 described herein. Alternatively, if marketplace platform system 120 were to determine that no additional gaming environments and gaming systems require processing (e.g., step 558; NO), exemplary process 560 is then complete in step 562.

Once matched, the method proceeds to step 556, where game advertisement data is stored in a database, such as in a database of data warehouse 116. The game advertisement data identifies and characterizes the matched product advertisement and game. For example, game advertisement data for the game may identify a set of candidate product advertisements that may be displayed to a user playing the game.

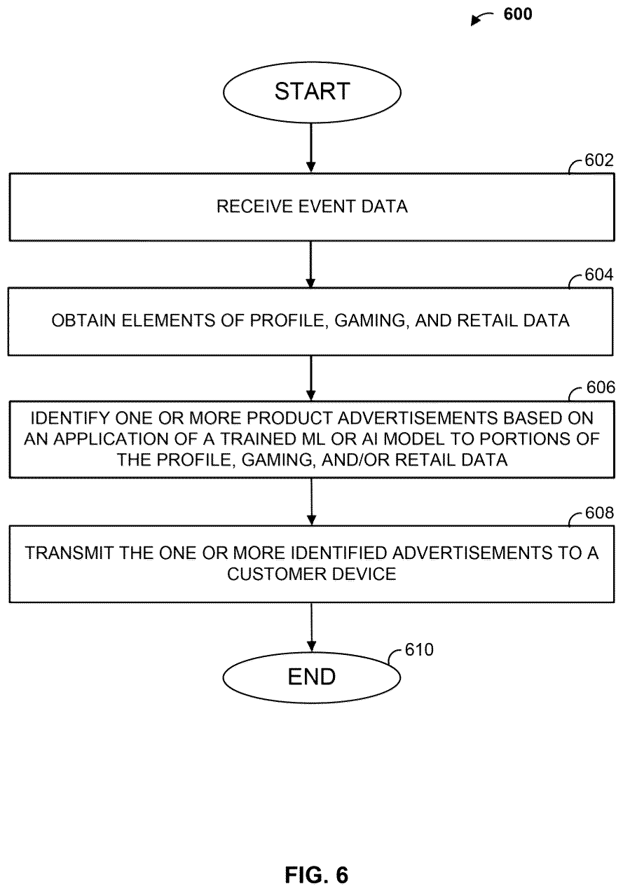

FIG. 6 is a flowchart of an exemplary process 600 for provisioning product advertisements to a user within a digital content presented by an executed application program, consistent with certain disclosed embodiments. In some examples, a computing system associated with an electronic marketplace platform within environment 100, such as marketplace platform system 120, may perform one or more of the exemplary steps of process 600.

As illustrated in FIG. 6, marketplace platform system 120 may receive event data identifying and characterizing an interaction between a user of computing device (e.g., the user of customer computing device 110A of FIG. 3) and elements of digital content presented to the user by an application program executed by that customer computing device 110A (e.g., in step 602). For example, and as described herein, customer computing device 110A may execute gaming application 302 that integrates an SDK 304 associated with, and provisioned by, marketplace platform system 120, and executed gaming application 302 may cause customer computing device 110A to present, within a corresponding gaming interface, elements of digital content that collectively establish a gaming environment that facilitates interaction between the user and a corresponding video game.

In some instances, marketplace platform system 120 may receive the event data from executed gaming application 302 via a secure, programmatic channel of communication, and the received event data may identify and characterize both the user and the gaming environment (and corresponding video game) established by executed gaming application 302. For example, event data 301 may identify the gaming environment through a corresponding game identifier (e.g., game name 441 of FIG. 4C), and may identify the user by a corresponding user identifier (e.g., a login credential, such as a username).

Marketplace platform system 120 may perform operations that access data warehouse 116, and obtain elements of profile data associated with the user identifier, elements of gaming data associated with game identifier, and elements of retail data identifying and characterizing one or more candidate product advertisements available for presentation within the gaming environment (e.g., in step 604). Further, and using any of the exemplary processes described herein, marketplace platform system 120 may apply a trained ML or AI model to a determined set of input data that includes all, or a selected portion, of elements of profile, gaming, and retail data (along with the elements of event data described herein), and based on the application of the trained ML or AI model, marketplace platform system 120 may identify one or more product advertisements appropriate to the user and for display within the ongoing gaming environment established by executed gaming application 302 (e.g., in step 606).

Marketplace platform system 120 may also perform any of the exemplary processes described herein to transmit the one or more identified product advertisements across network 118 to customer computing device 110A (e.g., in step 608). As described herein, executed gaming application 302 may perform any of the processes described herein to store the one or more product advertisements within a locally accessible data repository, and further, to present the one or more advertisements as part of a marketplace GUI that obscures all or a selected portion of the digital content associated with the ongoing gaming environment established by executed gaming application 302, e.g., in response to a detection selection of marketplace icon and the presentation of GUI 450 of FIG. 4D. Exemplary process 600 is then complete in step 610

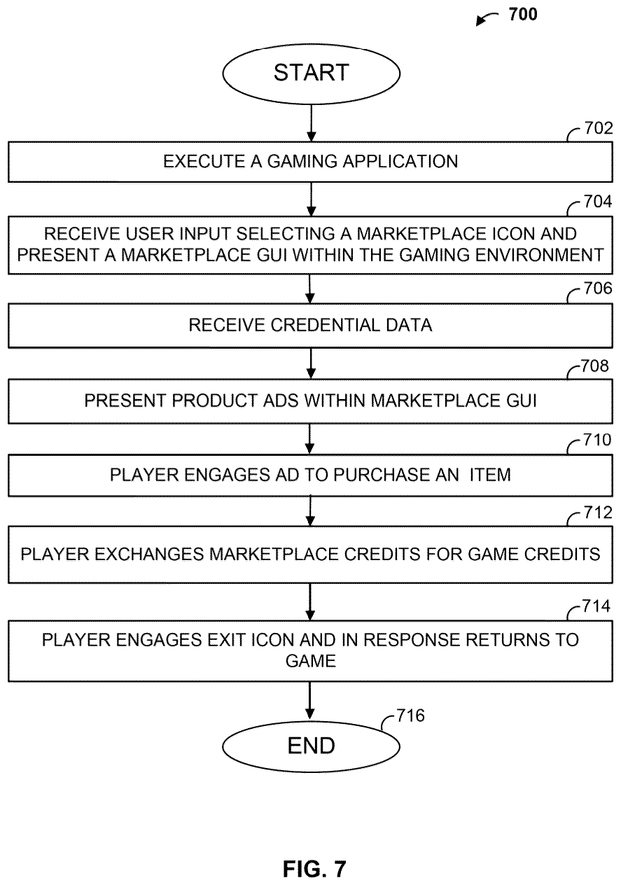

FIG. 7 is a flowchart of an exemplary process 700 for allocating, redeeming, and exchanging marketplace credits, consistent with certain disclosed embodiments. In some examples, one or more computing systems or devices operating within environment 100, such as a customer computing device (e.g., a corresponding one of customer computing device 110A, 110B, or 110C) and marketplace platform system 120, may perform one or more of the exemplary steps of process 700.

In FIG. 7, the customer computing device may execute an application program, such as a gaming application that establishes a digital environment (e.g., a gaming environment) with which a corresponding user may interaction (e.g., in step 702). In some instances, the execution of the gaming application may enable the user to “play” a corresponding video game and enables that user to enter the gaming environment, and the executed gaming application may be provisioned to the customer computing device by a corresponding one of content provider computing devices 114A or 114B.

In some instances, the executed gaming application may present, to the user, one or more elements of digital content within a corresponding gaming interface (e.g., that collectively establish the gaming environment) along with one or more selectable interface elements, such as a marketplace icon associated with marketplace platform system 120. The customer computing device may, for example, receive input from the user selecting the marketplace icon, and based on the received input, the executed gaming application (e.g., that integrated the SDK associated with marketplace platform system 120) may cause the customer computing device to generate and present a marketplace GUI within the corresponding gaming interface to the user (e.g., in step 704). The marketplace GUI may, for example, obscure all or a selected portion of the digital content establishing the gaming environment, and may enable the user to interact with the marketplace platform system 120 within exiting the gaming environment.

Responsive to the presentation of the marketplace GUI, the customer computing device receives further input specifying one or more elements of credential data associated with the user, and may route the elements of credential data, along with additional information identifying the executed gaming application, to marketplace platform system 120 (e.g., in step 706). In some examples, marketplace platform system 120 may perform operations that authenticate the credential data, and access one or more elements of profile data associated with the user, e.g., as maintained within data warehouse 116. As described herein, the elements of profile data may identify and characterize the user, and may include, but is not limited to, billing information and contact information (e.g., address, phone number) for the user. Through an implementation of any of the exemplary processes described herein, marketplace platform system 120 may identify one or more product advertisements appropriate for presentation within the marketplace GUI (e.g., in step 708), and transmit the one or more product advertisements to the customer computing device, e.g., for storage in a locally accessible data repository.

Referring back to FIG. 7, the executed gaming application may present all, or a selected subset, of the identified product advertisements within the marketplace GUI (e.g., in step 710), and the customer computing device may receive further input indicative of a request, by the user, to purchase a product or service associated with one of the presented products advertisements without existing the gaming environment (e.g., in step 712). For example, and within a particular one of the presented advertisements, the further input may be associated with a selection of an interface elements that adds the product of service to the user's online shopping cart (e.g., the selection of add-to-cart icon 462 of FIG. 4E), and the selection of an additional interface elements that initiates the purchase using the account information maintained within the profile data associated with the user (e.g., the selection of checkout icon 474A of FIG. 4F). In response to the further input, the customer computing device may transmit a purchase request to marketplace platform system 120, which may perform any of the exemplary processes described herein to complete the purchase and allocate the user with a specific number of marketplace credits associated with the now-purchased item.

Further, in some instances, the customer computing device may also receive input indicative of a decision, by the user, to exchange all or a selected subset of the allocated marketplace credits for in-game credits usable within the ongoing gaming environment (e.g., in step 712). For example, the received input (e.g., in step 712) may be indicative of a selection, by the user, of an additional interface element within the marketplace GUI (e.g., claim icon 494 of FIG. 4H) associated with the exchange of the allocated marketplace credits for in-game credits based on a predetermined or dynamically changing exchange ratio (e.g., currency value 449). At step 714, the user provides further input to the customer computing devices exists the marketplace GUI, and the executed gaming application may perform operations that remove the marketplace GUI from the gaming interface, e.g., without removing the user from the gaming environment. Exemplary process 700 is then complete in step 716.

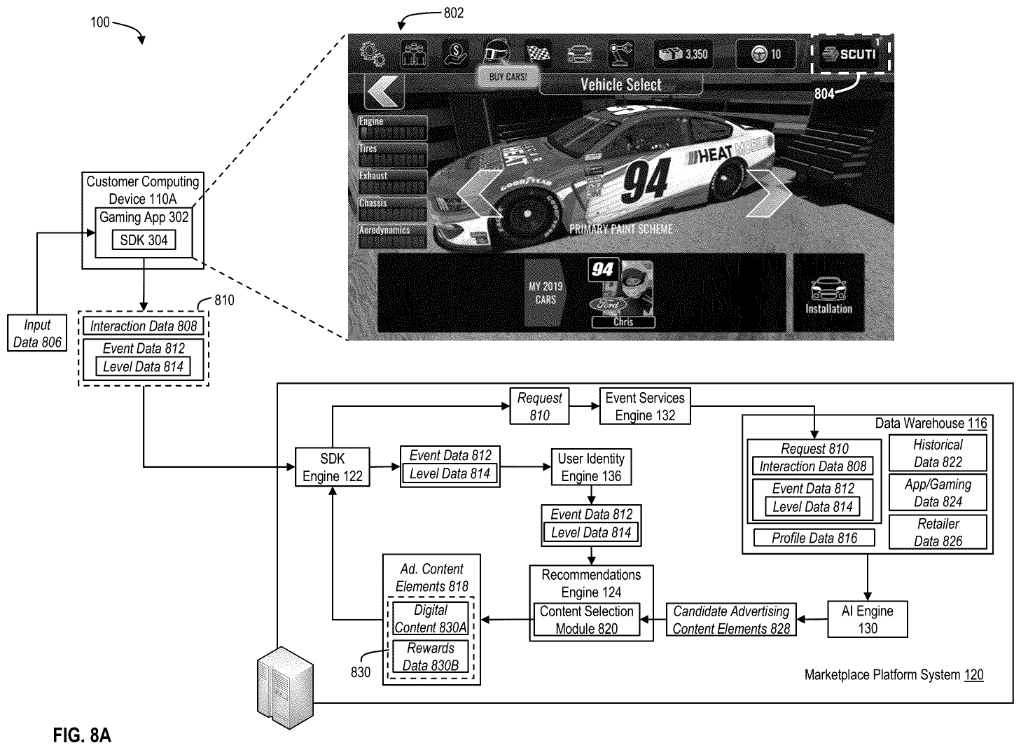

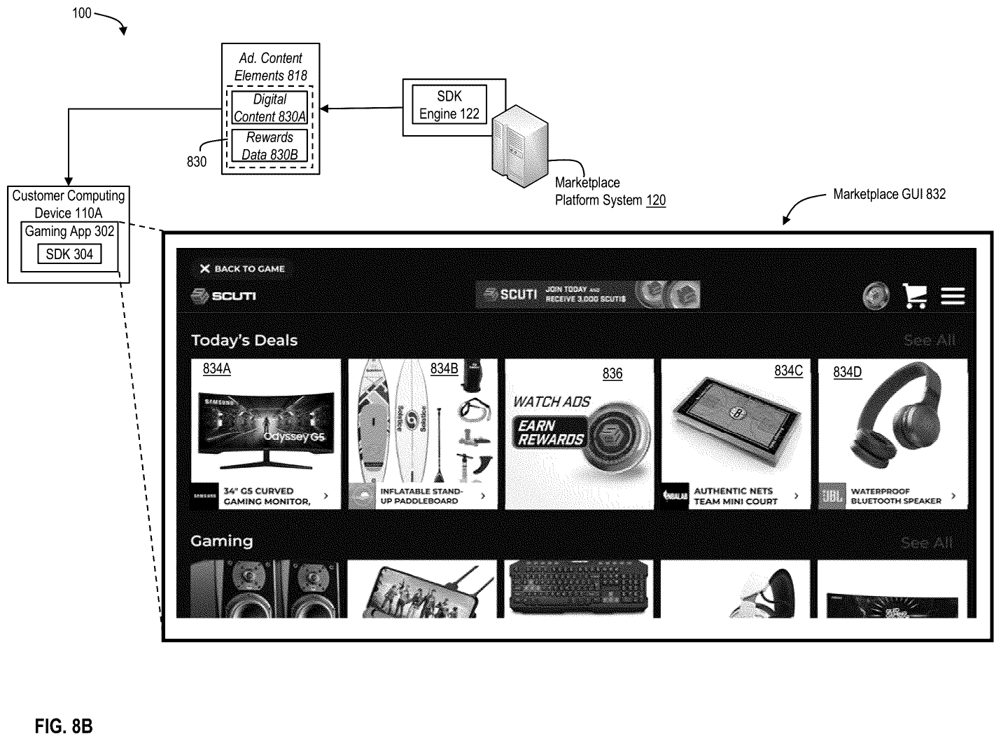

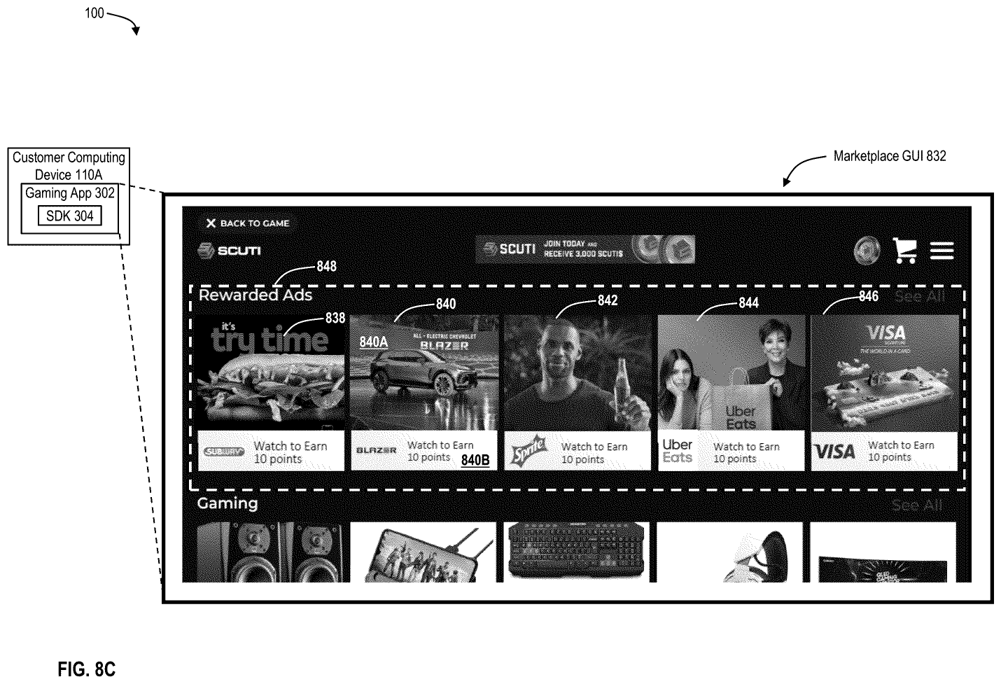

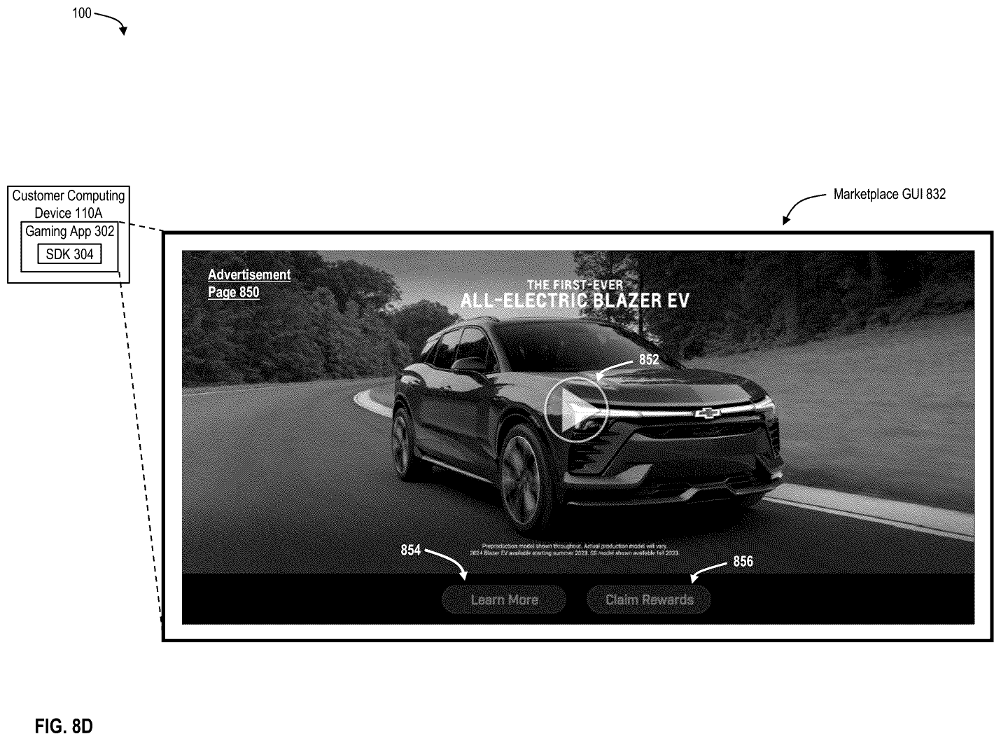

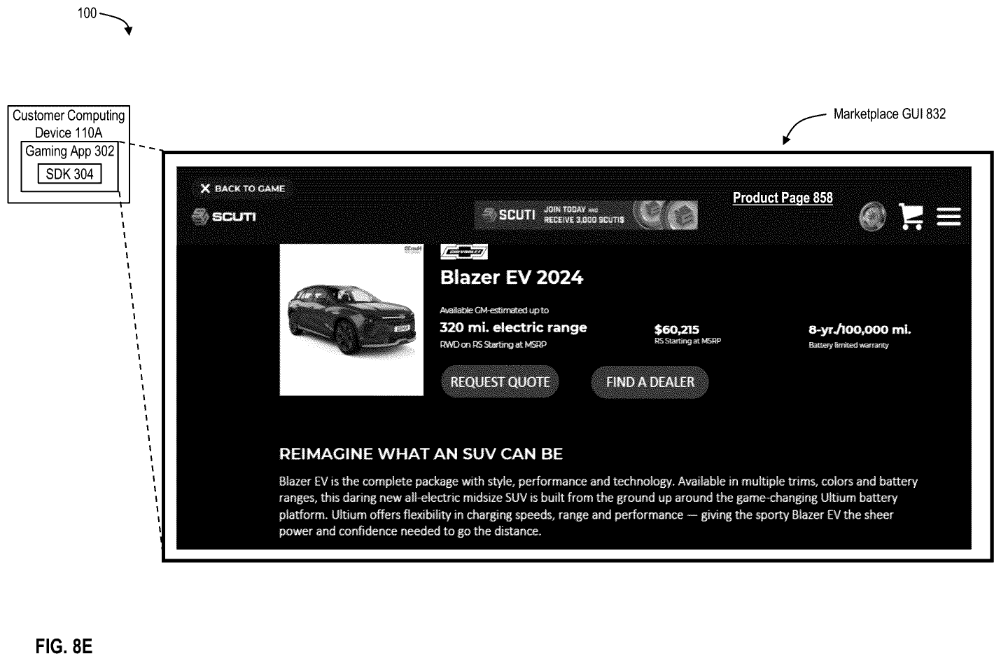

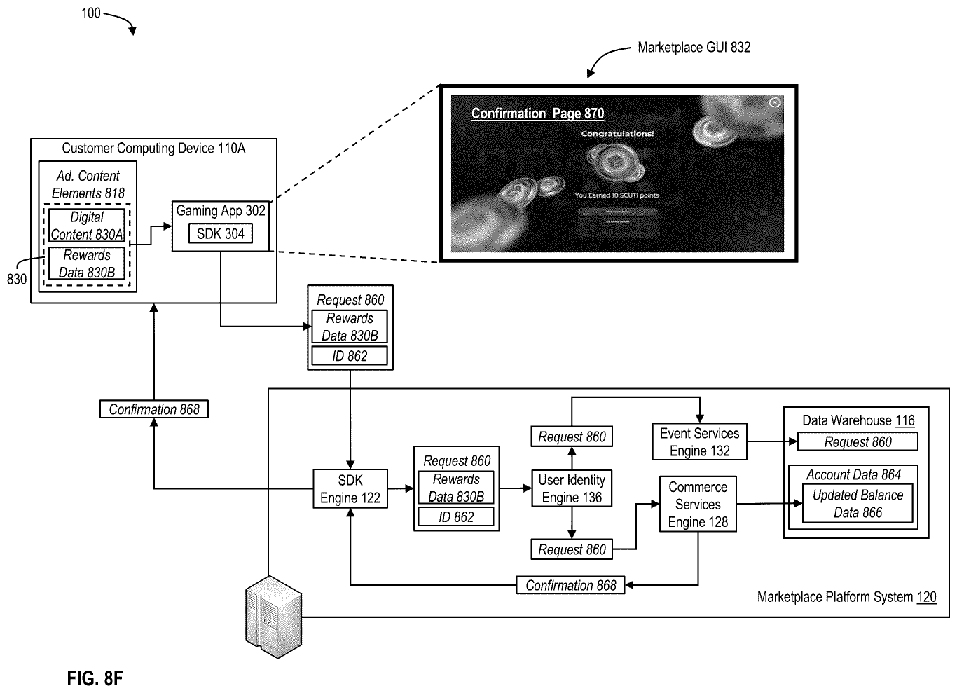

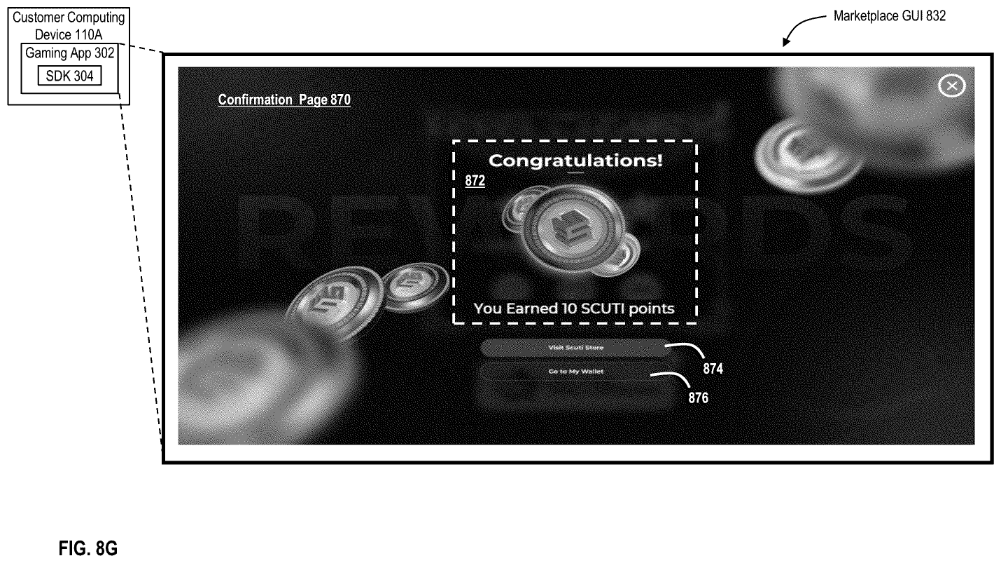

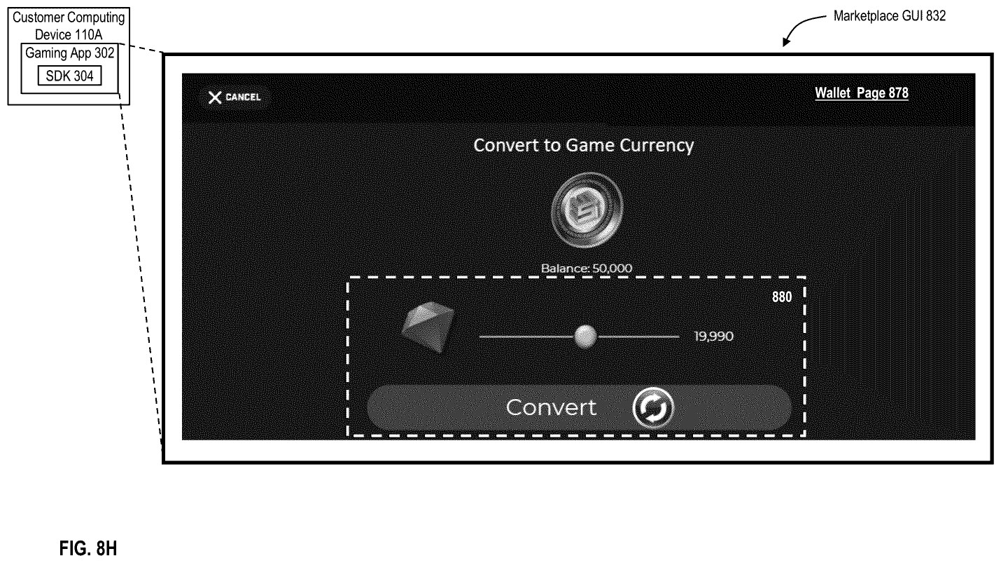

FIG. 8A is a diagram illustrating an exemplary portion of computing environment 100, consistent with certain disclosed embodiments. By way of example, referring to FIG. 8A, the one or more processors of marketplace platform system 120 may execute SDK engine 122, and executed SDK engine 122 may provide an interface, such as a communication endpoint (e.g., HTTP endpoint) or programmatic interface (e.g., an application programming interface (API) through which executed application programs or executed gaming applications that integrate the SDK may exchange data with marketplace platform system 120 and as such, with the exemplary electronic marketplace platform described herein.

Further, and as described herein, the computer-implemented digital platform and electronic marketplace associated with, and supported by, marketplace platform system 120 may be accessible to one or more executed application programs that integrate the SDK associated with marketplace platform system 120 and that are executable by one or more of customer computing devices 110A, 110B, and 110C. For example, as illustrated in FIG. 8A, customer computing device 110A may execute gaming application 302, which integrates SDK 304 associated with and provisioned by marketplace platform system 120. Executed SDK engine 122 may perform any of the exemplary processes described herein to provision elements of digital content (e.g., icons, interface elements, visual components) to executed gaming application 302 that are suitable for display within the context of the gaming environment provided by executed gaming application 302, and in some instances, the provisioned elements of digital content may represent portions of the gaming environment itself, e.g., as a portion of streaming gaming environment.

Using any of the exemplary processes described herein, SDK 304 may cause executed gaming application 302 to present all, or a selected portion of, the provisioned elements of digital content to a user interacting with executed gaming application 302, e.g., within a digital interface 802 via a corresponding display unit, such as a pressure-sensitive touchscreen display, etc. (not illustrated in FIG. 8A). In some instances, digital interface 802 may be associated with executed gaming application 302, and may include additional interface elements that facilitate access to the marketplace platform system 120 by the user interacting with executed gaming application 302. For example, the elements of digital content presented within digital interface 802 may establish collectively a “lobby” associated with executed gaming application 302 and additionally, or alternatively, a “main menu” associated with executed gaming application 302.

As illustrated in FIG. 8A, the additional interface elements presented within digital interface 802 may include a marketplace icon 804 that, upon engagement or selection by the user, causes executed gaming application 302 (and integrated SDK 304) to perform any of the exemplary processes described herein that, in conjunction with executed SDK engine 122 of marketplace platform system 120, present the marketplace GUI to the user via the corresponding display unit. For example, the user may provide input to customer computing device 110A (e.g., via a corresponding input device, such as the pressure-sensitive touchscreen display described herein, etc.) that selects or engages with marketplace icon 804, and based on the received user input, the corresponding input device (not illustrated in FIG. 8A) may generate elements of input data 806 indicative of the user's selection of, or engagement with, marketplace icon 804, which may be provisioned to executed gaming application 302. Based on the elements of input data 806, executed gaming application 108 may generate elements of interaction data 808 that further indicate the user's selection of, or engagement with, marketplace icon 804, and may package the elements of interaction data 808 into corresponding portions of a request 810 for advertising content appropriate to the user (e.g., via corresponding elements of profile data, etc.), the user's prior interactions with marketplace platform system 120 and the computer-implemented marketplace associated with marketplace platform system 120, and additionally, or alternatively, with executed gaming application 302.

For instance, executed gaming application 302 may generate event data 812 that identifies the user (e.g., via corresponding, alphanumeric authentication credentials, a digital token, etc.) and further, that also identifies and characterizes an activity of the user within the gaming environment associated with, and established by, executed gaming application 302. By way of example, the gaming environment may be associated with a plurality of discrete, and increasing challenging, levels of gameplay, and portions of event data 812 may indicate a completion of a corresponding one of the levels of gameplay and include information, such as level data 814, that identifies the completed level of gameplay and additionally or alternatively, characterizes a complexity of the completed level of gameplay. In other instances, although not illustrated in FIG. 8A, executed gaming application 302 may detect a completion of the corresponding level of gameplay by the user, and responsive to the detected completion of the corresponding level of gameplay, executed gaming application 302 may generate level data 804 that identifies the completed level of gameplay and/or characterizes the complexity of the completed level of gameplay.

Executed gaming application 302 may cause customer computing device 110A to transmit request 810, which includes interaction data 808 and event data 812 (e.g., and in some instances, the elements of level data 804) across network 118 to marketplace platform system 120. As illustrated in FIG. 8A, executed SDK engine 122 may receive request 810, including the elements of interaction data 808, event data 812, and in some instances, the elements of level data 814, across network 118 from customer computing device 110A (e.g., via transceiver 204 through a corresponding programmatic interface, such as an application programming interface (API)), and executed SDK engine 122 may route request 810 to event service engine 132, which may be executed by the one or more processors of marketplace platform system 120. Executed event service engine 132 may perform operations that log the receipt of request 810 within a corresponding event log (e.g., maintained within data warehouse 116), and may store request 810 (including the elements of interaction data 808, event data 812, and/or level data 814) within a portion of data warehouse 116, e.g., in conjunction with corresponding elements of profile data 816 characterizing the user.

Further, in some instances, executed SDK engine 122 may also perform operations that parse the received elements of interaction data 808, event data 812, and/or level data 814 for further distribution to other software engines executed by marketplace platform system 120, such as those described herein. For example, based on the elements of interaction data 808, which indicate the user's selection of, or engagement with, marketplace icon 804, executed SDK engine 122 may route all or a selected portion of event data 802 to user identity engine 136. Upon execution by the one or more processors of marketplace platform system 120, executed user identity engine 136 may perform any of the exemplary processes described herein to authenticate an identity of the user associated with customer computing device 110A based on copies of locally stored login and authentication credentials (e.g., as maintained within data warehouse 116). If, for example, if executed user identity engine 136 were unable to authenticate the identity of the user, or if executed user identity engine 136 were to determine that a marketplace account does not exist exists for the user, executed user identity engine 136 may generate and transmit an error message across network 120 to customer computing device 110 (not illustrated in FIG. 8A). For example, if executed user identity engine 136 were to determine that the marketplace account does not exist exists for the user, the error message may provide additional data to executed gaming application 302 that, when presented to the user within a corresponding digital interface, prompts the user to create a marketplace account.

Alternatively, based on a successful authentication of the identity of the user, executed user identity engine 136 may provide portions of event data 812, including the elements of level data 814, as inputs to recommendation engine 124, which may be executed by the one or more processors of marketplace platform system 120. In some instances, executed recommendation engine 124 may perform any of the exemplary processes described herein to select one or more elements 818 of advertising content appropriate to the user, to the user's prior interactions with marketplace platform system 120 and the computer-implemented marketplace associated with marketplace platform system 120, and additionally, or alternatively, to the gaming environment established by and associated with executed gaming application 302 (e.g., to the completed level of gameplay and the complexity of that completed level of gameplay). For example, responsive to a receipt of the portions of event data 812, executed recommendations engine 124 may obtain, from data warehouse 116, previously identified elements of advertising content appropriate to the user and to the gaming environment, and a content selection module 820 of executed recommendations engine 124 may perform any of the exemplary processes described herein to select advertising content elements 818 from among the obtained and previously identified elements of advertising content.

Further, in some examples, AI engine 130 may, upon execution by the one or more processors of marketplace platform system 120 (e.g., based on programmatic commands generated by executed recommendations engine 124), perform any of the exemplary processes described herein to identify or select one or more “candidate” advertisements appropriate to the user, the user's prior interactions with marketplace platform system 120 and the computer-implemented marketplace associated with marketplace platform system 120, and additionally, or alternatively, with executed gaming application 302 based on an application of a trained machine learning (ML) or artificial intelligence (AI) process to a dynamically determined set of input data (e.g., as selected via feature engineering, etc.). Examples of the ML or AI models may include, but are not limited to, a deep neural network and one or more decision tree models, such as a boosted decision tree model. Further, the set of input data may include, but is not limited to: one or more elements of profile data 816 characterizing the user; one or more of the elements of event data 812 and level data 816; one or more elements of historical data 822 (e.g., as maintained within data warehouse 116) characterizing prior interactions between the user and the computer-implemented marketplace (e.g., data indicating previous activity with the computer-implemented electronic marketplace, such as historical impressions or purchases); elements of application or gaming data 824 associated with executed gaming application 302 (e.g., rules or requirements game developers configure when adding gaming application 302 to the marketplace network); and/or elements of retailer data 826 (e.g., rules or requirements retailers configure when adding a product to the computer-implemented electronic marketplace).

Based on an application of the trained ML or AI process to the dynamically determined set of input data, executed AI engine 130 may perform operations, described herein, to determine one or more candidate elements 828 of advertising content that would be appropriate to the user, to the user's prior interactions with marketplace platform system 120 and the computer-implemented marketplace associated with marketplace platform system 120, and additionally, or alternatively, to the gaming environment established by and associated with executed gaming application 302. In some instances, executed AI engine 130 may provision all, or a subset, of candidate advertising content elements 828 as inputs to executed recommendations engine 124, content selection module 820 of executed recommendations engine 124 may perform any of the exemplary processes described herein to select advertising content elements 818 from among candidate advertising content elements 828.

For example, executed content selection module 820 may perform operations that select all, or a corresponding subset, of candidate advertising content elements 828 for provisioning to executed gaming application 302, e.g., as advertising content elements 818. In some instances, executed content selection module 820 may select the subset of candidate advertising content elements 828 that establish collectively advertising content elements 818 (or establish a sequential ordering of candidate advertising content elements 828 within advertising content elements 818) based on an application of one or more random selection processes to candidate advertising content elements 828. Examples of these random selection processes may include, but are not limited to, a simple random sampling process (e.g., an equal probability sampling process, a selection-rejection process, a reservoir sampling process, etc.), a systemic random sampling process, a stratified sampling process, or a cluster sampling process, and executed content selection module 820 may apply one or more of these exemplary random selection processes to data characterizing corresponding ones of the candidate advertising content elements 828 (e.g., as maintained in data warehouse 116, etc.). The disclosed embodiments are, however, not limited to these exemplary selection processes, and in further examples, executed content selection module 202 may select the determined number of the candidate advertising content elements 828 (e.g., the discrete elements of advertising content elements 818) based on an application or implementation of any additional, or alternate, selection process appropriate to candidate advertising content elements 828, such as, but not limited to, selection processes informed by the level of game play characterized by level data 814.

As described herein, each of advertising content elements 818 may characterize a corresponding product-, service-, and/or retailer-specific advertisement, and may include corresponding elements of digital content that, when rendered for presentation within the marketplace GUI by executed gaming application 302, identify and characterize the corresponding product-, service-, and/or retailer-specific advertisement. Examples of the elements of digital content associated with advertising content elements 818 may include, but are not limited to, a static digital image, a GIF, or a digital video of a predetermined length (e.g., a commercial run of fifteen seconds, thirty seconds, sixty seconds, etc.)

In some instances, the product-, service-, and/or retailer-specific advertisements may include one or more “rewarded” advertisements, and each of the one or more rewarded advertisements may be associated with a corresponding, product-, service-, and/or retailer-specific prize or “reward.” Examples of the advertisement-specific reward or prize may include, but are not limited to, one or more units of the exemplary marketplace credits described herein, which may be redeemed through any of the gaming environments (or other digital or virtual environments, such as metaverses) associated and operable with the computer-implemented electronic marketplace established and maintained by marketplace platform system 120. Further, examples of the advertisement-specific reward or prize may also include, but are not limited to, a discount on a retail price of the corresponding product or service, or on a specified quantity of the corresponding product or service (e.g., a “buy one, get one” at a predetermined discount, etc.), when purchased through the electronic marketplace, a sample of the corresponding product or service available for provisioning through the electronic marketplace, or any additional, or alternate, promotional offer associated with the corresponding product, service, or merchant or retailer. In some instances, marketplace platform system 120 may perform any of the exemplary processes described herein to provision the advertisement-specific reward or prize to the user (e.g., to allocate the specified quantity of the marketplace credits to a digital wallet of the user, as described herein, etc.) in response to a successful, and completed, presentation of the full commercial run of the corresponding rewarded advertisement within the marketplace GUI by executed gaming application 302.

By way of example, each rewarded advertisement may be associated with a corresponding one of advertising content elements 828, which may include elements of digital content that characterize the respective rewarded advertisement (e.g., the static digital image, GIF, digital video of the predetermined length) and elements of reward data that identify and the characterize the corresponding, advertisement-specific prize available for provisioning to the user. For instance, as illustrated in FIG. 8A, advertising content elements 818 may include advertising content element 830 associated with a corresponding one of the rewarded advertisements, such as, but not limited to, a sixty-second commercial advertising an electric vehicle, and advertising content element 830 may include digital content 830A that characterizes the corresponding rewarded advertisement, such as, but not limited to, a digital video having a commercial run of sixty seconds.

Further, advertising content element 830 may also include rewards data 830B that identifies and characterizes an advertisement-specific reward available for provisioning to the user upon a presentation of the complete, commercial run of the sixty-second digital video within the marketplace GUI by executed gaming application 302, such as, but not limited to, an allocation of ten marketplace credits to a digital wallet maintained by the user. The elements of rewards data 830B associated with the corresponding rewarded advertisement may, for example, include an identifier of the advertisement-specific reward, such as the redeemable marketplace credits described herein, and a quantity of the redeemable marketplace credits available for allocation upon successful presentation of the corresponding rewarded advertisement (e.g., ten credits, etc.). The disclosed embodiments are, however, not limited to these exemplary rewarded advertisements or to these exemplary advertisement-specific rewards or prices, and in other instances, advertising content elements 816 may be associated with any additional or alternate number or type of rewarded advertisements, and may characterize any additional or alternate type or quantity of advertisement-specific reward or price, that would be appropriate to executed gaming application 302 or to the computer-implemented marketplace associated with marketplace platform system 120.

Executed recommendations engine 124 may route advertising content elements 818, which include the determined number of discrete elements of advertising content that are appropriate to the user, to the user's prior interactions with marketplace platform system 120 and the computer-implemented marketplace platform associated with marketplace platform system 120, and additionally, or alternatively, with executed gaming application 302, to executed SDK engine 122. Referring to FIG. 8B, executed SDK engine 122 may perform operations that cause marketplace platform system 130 to transmit advertising content elements 818 across network 118 to customer computing device 110. In some instances, a programmatic interface associated with SDK 304 or executed gaming application 302 (e.g., an application programming interface (API)) may receive advertising content elements 818 from marketplace platform system 120, and executed gaming application 302 may perform operations that store advertising content elements 828 within a portion of a tangible, non-transitory memory of customer computing device 110A.

As illustrated in FIG. 8B, executed gaming application 302 may also perform operations that render the elements of digital content included within advertising content elements 818, and other locally maintained elements of digital content, for presentation within portions of a platform-specific digital interface, such as a marketplace graphical user interface (GUI) 832, e.g., via a corresponding display unit, such as a pressure-sensitive touchscreen display, etc. For example, marketplace GUI 832 may include one or more interface elements that identify and characterize the product-, service-, and/or retailer-specific advertisements associated with corresponding ones of advertising content elements 828, such as, but not limited to interface elements 834A, 834B, 834C, and 834D. As described herein, each, or a subset, of interface elements 834A, 834B, 834C, and 834D may include an image associated with a product, service, or retailer or merchant associated with the corresponding one of the product-, service-, and/or retailer-specific advertisements (and in some instances, a price or a review of the product, service, or retailer or merchant). Further, as described herein, marketplace GUI 832 may also include, but is not limited to: (i) a redemption icon that, if selected by the user (e.g., based on input provided to customer computing device 110A), causes executed gaming application 302 (via SDK 304) to request a redemption of a specified quantity of marketplace credits using any of the exemplary processes described herein; and (ii) an online shopping cart icon that, if selected by the user (e.g., based on input provided to customer computing device 110A), displays an online shopping cart that facilitates the purchase of products within the computer-implemented marketplace using any of the exemplary processes described herein, e.g., without exiting the digital gaming environment associated with executed gaming application 302 (or without exiting a metaverse or other virtualized digital environment).

Although not illustrated in FIG. 8B, the user may provide input to customer computing device 110A that selects a product-, service-, and/or retailer-specific advertisement associated with one of interface elements 834A, 834B, 834C, and 834D, which may cause executed gaming application 302 to perform any of the exemplary processes described herein to present, via the corresponding display unit, a further GUI that includes additional details characterizing the product, service, and/or retailer associated with the selected product-, service-, and/or retailer-advertisement (e.g., additional images of or digital content describing the product, service, and/or retailer, etc.). In some instances, the further GUI may include interface elements that facilitate a configuration of one or more options associated with the product, service, and/or retailer by the user, or a purchase of a determined quantity of the product, service, and/or retailer by the user using fiat currency or a conversion of allocated marketplace credits, based on further input provided by the user to customer computing device 110A, e.g., via the corresponding input unit.

Further, and as described herein, each of a subset of advertising content elements 828 maintained within the portion of the tangible, non-transitory memory of customer computing device 110A may be associated with, and may characterize, a rewarded advertisement, which may be associated with a corresponding, product-, service-, and/or retailer-specific prize or reward available for allocation to the user upon a complete presentation of the corresponding element of advertising content (e.g., an “advertisement-specific” reward). For example, advertising content elements 818 may include advertising content element 830, which may be associated with the sixty-second commercial advertising the electric vehicle, and as described herein, advertising content element 830 may include digital content 830A associated with the sixty-second commercial (e.g., a sixty-second digital video), which executed gaming application 302 may present within marketplace GUI 832) and rewards data 830A, which identifies and characterizes the advertisement-specific reward available to the user upon the presentation of the complete commercial run of the sixty-second commercial to the user within marketplace GUI 832, such as, but not limited to, ten marketplace credits.

In some instances, SDK 304 may cause executed gaming application 302 to parse advertising content elements 818 and detect a presence of the subset of advertising content elements 818 associated with the rewarded advertisements. Based on the detection of the subset of advertising content elements 818, SDK 304 may cause executed gaming application 302 to generate, and present within marketplace GUI 832, an additional interface element 836 that prompts the user to view one or more of the rewarded advertisements within marketplace GUI 832 (e.g., without exiting the digital gaming environment associated with executed gaming application 302 or without exiting a metaverse or other virtualized digital environment) and to “earn” the advertisement-specific reward associated with corresponding ones of the rewarded advertisements. For example, upon viewing additional interface element 836 within marketplace GUI 832, the user may elect to inspect one or more of the rewarded advertisements within marketplace GUI 832, and may provide additional input to customer computing system 110A (e.g., via the corresponding input unit) that selects, or engages with, additional interface element 836.

Based input data characterizing the selection of, or the engagement with, additional interface element 836 (e.g., which may be generated by the corresponding input unit in response to the receipt of the additional input), executed gaming application 302 may perform operations that obtain the subset of advertising content elements 818 associated with the rewarded advertisements from the portion of the tangible, non-transitory memory of customer computing device 110A. Executed gaming application 302 may perform operations that, for one or more of the subset of advertising content elements 818 associated with the rewarded advertisements, generate an interface element (e.g., a reward-based interface element) associated with the corresponding one of the rewarded advertisements, and that cause customer computing device 110A to present the one or more reward-based interface elements within a corresponding portion of marketplace GUI 832, e.g., via the corresponding display unit.

Referring to FIG. 8C, executed gaming application 302 may cause customer computing device 110A to present the generated, rewards-based interface elements associated with the corresponding ones of the rewarded advertisements, including, but not limited to, rewards-based interface elements 838, 840, 842, 844, and 846, within a corresponding portion 848 of marketplace GUI 832. In some instances, portion 848 of marketplace GUI 832, and each of rewards-based interface elements 838, 840, 842, 844, and 846, may replace, or may obscure at least a portion of, interface elements 834A, 834B, 834C, 834D, and 836 within marketplace GUI 832 (e.g., in response to the user's selection of additional interface element 836). Further, as illustrated in FIG. 8C, each of rewards-based interface elements 838, 840, 842, 844, and 846 may include a portion of the digital content associated with the corresponding one of the rewarded advertisements, such as, but not limited to, a thumbnail or portion of the corresponding digital image or a screenshot of or a portion of the corresponding digital video, and may include additional digital content that characterizes the reward or prize associated with the complete presentation of the corresponding one of the rewarded advertisements (e.g., in accordance with the corresponding rewards data).

In some instances, the user may elect to view the rewarded advertisement associated with one, or more, of rewards-based interface elements 838, 840, 842, 844, and 846 presented within marketplace GUI 832, and may provision additional input to customer computing device 110A that selects a respective one of rewards-based interface elements 838, 840, 842, 844, and 846 for further interaction (e.g., the corresponding input unit). Based on input data characterizing the selection of a respective one of rewards-based interface elements 838, 840, 842, 844, and 846 (e.g., generated by the input unit), executed gaming application 302 may perform operations, in conjunction with SDK 304, that access a corresponding one of advertising content elements 818 associated with the selected one of rewards-based interface elements 838, 840, 842, 844, and 846, and obtain the elements of digital content that establish the corresponding, rewarded advertisement, such as the digital image, the GIF, or the digital video described herein.

Executed gaming application 320 may also perform operations, in conjunction with SDK 304, that present the obtained elements of digital content, which establish collectively the corresponding one of the rewarded advertisements, to the user within a portion of marketplace GUI 832 (e.g., by obscuring all, or a portion, of portion 848). Further, upon completion of a complete, commercial run of the elements of digital content, executed gaming application 320 may, in conjunction with SDK 304, generate and present additional interface elements within marketplace GUI 832 (e.g., via the corresponding display unit) that prompt the user to request additional information characterizing the product, service, or merchant associated with the corresponding one of the rewarded advertisements (e.g., within an additional, or alternate, portion of marketplace GUI 832), or to request an allocation of the advertisement-specific reward associated with the corresponding one of the rewarded advertisements, e.g., using any of the exemplary processes described herein.

For example, rewards-based interface element 840 may be associated with advertising content element 830, and the rewarded advertisement for the electric vehicle, and as described herein, advertising content element 830 may include digital content 830A that characterizes the corresponding rewarded advertisement (e.g., the digital video having the commercial run of sixty seconds) and rewards data 830B that identifies and characterizes the ten marketplace credits available for allocation to the digital wallet of the user upon the complete presentation of the sixty-second commercial run of the digital video. As illustrated in FIG. 8C, rewards-based interface element 840 may include a portion 840A of digital content 830A, such as a screenshot of or a portion of the corresponding digital video that depicts visually the electric vehicle, and additional digital content 840B that depicts visually the ten marketplace credits available for allocation to the user's digital wallet, e.g., as a reward for viewing the complete, commercial run of the digital video.

The user may, in some instances, elect to view the rewarded advertisement associated with rewards-based interface element 840 (e.g., the sixty-second, digital video advertising the electric vehicle), and may provision additional input to customer computing device 110A that selects rewards-based interface element 840 for further interaction (e.g., the corresponding input unit). Based on input data characterizing the selection of rewards-based interface element 840 (e.g., generated by the input unit), executed gaming application 302 may perform operations, in conjunction with SDK 304, that obtain digital content 830A from advertising content element 830, and that present digital content 830A within a corresponding portion of marketplace GUI 832. For example, referring to FIG. 8D, executed gaming application 302 may present digital content 830A, e.g., the sixty-second digital video advertising the electric video within an advertisement page 850 of marketplace GUI 832, e.g., via the corresponding display unit. Advertisement page 850 may, for example, represent a pop-up window that obscures all, or a selected portion, of marketplace GUI 832, and advertisement page 850 may include an additional interface element, such as icon 852, that prompts the user to provide additional input that initiates a playback of the complete, commercial run of the sixty-second digital video advertising the electric video within advertisement page 850.

The user may, for instance, provide additional input to customer computing device 110A (e.g., via the corresponding input unit) that selects or engages with icon 852, and based on additional input data characterizing the selection of or engagement with icon 852 by the user (e.g., generated by the corresponding input unit), executed gaming application 302 may initiate the presentation of the sixty-second digital video advertising the electric video within advertisement page 850. Upon completion of the full, commercial run of the sixty-second digital video (e.g., the complete presentation of the advertisement), executed gaming application 302 may perform additional operations, in conjunction with SDK 304, that present, at corresponding positions within advertisement page 850, and product-specific icon 854, which enables the user to request additional information identifying and characterizing the product associated with the rewarded advertisement (e.g., the electric vehicle), and a rewards-specific icon 856, which enables the user to “claim” the corresponding reward associated with the completed presentation of the rewarded advertisement, e.g., to request the allocation of the ten marketplace credits to the user's digital wallet using any of the exemplary processes described herein.

By way of example, and prior to, or as an alternate to, claiming the corresponding reward, the user may elect to obtain additional information identifying and characterizing the electric vehicle, and the user may provide additional input to customer computing device 110A that select, or engages with, product-specific icon 854 (e.g., via the corresponding input unit). Based on input data characterizing the selection of, or engagement with, product-specific icon 854 (e.g., generated by the corresponding input unit), executed gaming application 302 may perform operations, in conjunction with SDK 304, that establish across network 118 a channel of communications with marketplace platform system 130 and additionally, or alternatively, one or more of retailer computing systems 112A and 112B associated with the electric vehicle, and that obtain data identifying and characterizing the electric vehicle from marketplace platform system 130, retailer computing system 112A, and/or retailer computing system 112B. Examples of the obtained information may include, but are not limited to, a values of one or more parameters of the electric vehicle (e.g., an electric range, etc.), a price of the electric vehicle, parameter values of a corresponding warranty, retailers capable of supplying the electric vehicle, a textual description of the electric vehicle, or an additional digital image or digital video.

Referring to FIG. 8E, executed gaming application 302 may perform operations, in conjunction with SDK 304, that populate a corresponding product page 858 with corresponding portions of the obtained information, and that present product page 858 within a corresponding portion of marketplace GUI 832, e.g., via the corresponding display unit. In some instances, presented product page 858 may obscure all, or a selected portion, of the interface elements presented within marketplace GUI 832, and product page 858 may include additional interface elements that, when selected or engaged by the user (e.g., via additional input provisioned by the user to the corresponding input unit of customer computing device 110A), enable the user to request a quoted price for the electric vehicle (e.g., valid over a particular temporal interval), to identify a retailer capable of supplying the electric vehicle, to purchase the electric vehicle, and/or to subscribe to future updates of the product pages.

In additional, or alternate, examples, the user may elect to “claim” the corresponding, advertisement-specific reward associated with the completed presentation of the rewarded advertisement (e.g., to request the allocation of the ten marketplace credits to the user's digital wallet using any of the exemplary processes described herein), and the may provide additional input to customer computing device 110A that select, or engages with, rewards-specific icon 856 (e.g., via the corresponding input unit). Based on additional input data generated by the corresponding input unit, which characterizes the user's selection of or engagement with rewards-specific icon 856, executed gaming application 302 may perform operations, in conjunction with SDK 304, that generate a request to collect the advertisement-specific reward associated with the completed presentation of the rewarded advertisement (e.g., the allocation of the ten marketplace credits to the user's digital wallet using any of the exemplary processes described herein), and to transmit the generated request across network 118 to marketplace platform system 120.

Referring to FIG. 8F, and responsive to the user's selection of, or engagement with, rewards-specific icon 856, executed gaming application 302 may generate a request 860 for the collection of the advertising-specific reward associated with the completed presentation of the full, sixty-second digital video advertising the electric vehicle. For example, executed gaming application 302 may obtain, from advertising content element 830 associated with the rewarded advertisement for the electric vehicle, one or more elements of reward data 830B that identify and characterize the corresponding, advertisement-specific reward (e.g., the allocation of the ten marketplace credits to the user's digital wallet), and executed gaming application 302 may package all, or a selected portion, of the elements of reward data 830B into corresponding portions of request 860. Further, if the user were to represent a registered user of marketplace platform system 120, executed gaming application may also package a unique identifier 862 of the registered user and/or an account held by that registered user within the electronic marketplace (e.g., a unique, alphanumeric user identifier, a unique account number, a digital token, etc.). As illustrated in FIG. 8F, executed gaming application 302 may cause customer computing system 110A to transmit request 860 across network 118 to marketplace platform system 120.

Executed SDK engine 122 of marketplace platform system 120 may receive request 860, including the rewards data 830B and identifier 862, from customer computing device 110A across network 118 from (e.g., via transceiver 204 through a corresponding programmatic interface, such as an application programming interface (API)). In some instances, executed SDK engine 122 may perform operations that provide all, or a portion of, request 860 as an input to user identity engine 136, which, upon execution by the one or more processors of marketplace platform system 120, may perform any of the exemplary processes described herein to authenticate an identity of a user associated with customer computing device 110A, and to determine whether the user represents a registered user of the electronic marketplace. If, for example, executed user identity engine 136 were to determine that the user does not represent a registered user of the electronic marketplace (or alternatively, that the user represents a registered user of the electronic marketplace that is not currently logged into the electronic marketplace), executed user identity engine 136 may perform operations that cause marketplace computing system 120 to generate and transmit an error message (not illustrated in FIG. 8F) across network 118 to customer computing device 110A that requests the user provide further input to customer computing device 110A (e.g., via the corresponding input unit) that logs in or “signs in” the user to the electronic marketplace or alternatively, that prompts the user to provide further input to customer computing device 110A that initiates a registration of the user for an account at the electronic marketplace.

Although not illustrated in FIG. 8F, a programmatic interface associated with SDK 304 or executed gaming application 302 (e.g., an application programming interface (API)) may receive the error message, and may perform operations that render all or a selected portion of the received message for presentation within a portion of marketplace GUI 832 via the corresponding display unit. For example, executed gaming application 302 may process the received error message, and may perform operations that generate additional interface elements that, when presented within marketplace GUI 832, prompt the user to “sign into” the electronic marketplace (e.g., by providing additional input to customer computing device 110A that selects interactive interface elements 1002A using any of the exemplary processes described herein) or to register for an account maintained by the electronic marketplace (e.g., by providing additional input to customer computing device 110A that selects the additional interface elements using any of the exemplary processes described herein).

Alternatively, referring back to FIG. 8F, if executed user identity engine 136 were to determine that the user represents a registered user of the electronic marketplace, and further, that the user is currently logged into the electronic marketplace, executed user identity engine 136 may route request 860 (including the elements of rewards data 830B and identifier 862) to event service engine 132 executed by the one or more processors of marketplace computing system 120, and executed event service engine 132 may store request 860 within a tangible, non-transitory memory accessible to marketplace platform system 120, e.g., a portion of data warehouse 116. Executed user identity engine 136 may also provide all, or selected portion, of request 860 (including the elements of rewards data 830B and identifier 862) as an input to a commerce services engine 128 executed by the one or more processors of marketplace platform system 130, which may perform any of the exemplary processes described herein to provision the advertisement-specific reward to the user in accordance with the elements of rewards data 830B.

As described herein, the advertisement-specific reward may include the allocation of the ten marketplace credits to the account of the user within the electronic marketplace (e.g., to the user's digital wallet), and in some instances, executed commerce services engine 128 may parse request 860 and obtain identifier 862 of the registered user and/or the account held by that registered user within the electronic marketplace (e.g., of the user's digital wallet), and the elements of rewards data 830B that identify and characterize the allocation of the ten marketplace credits. Based on identifier 822, executed commerce services engine 128 may, for example, access account data 864 that characterizes the account held by that registered user within the electronic marketplace, and the account data may identify, among other things, a current balance of marketplace credits held by the user. Based on the elements of rewards data 830B, executed commerce services engine 128 may perform operations that allocate the ten marketplace credits to the user and generate elements of updated balance data 866 that confirm the allocation of the ten marketplace credits and indicate an updated balance of the marketplace credits held by the user. As illustrated in FIG. 8F, executed commerce services engine 128 may store the elements of updated balance data 866 within a corresponding portion of account data 864 (e.g., within data warehouse 116), and may route a confirmation 868 of the now-allocated marketplace credits to executed SDK engine 122, which may perform operations that transit confirmation 868 across network 118 to customer computing device 110A.

Although not illustrated in FIG. 8F, a programmatic interface associated with SDK 304 or executed gaming application 302 (e.g., an application programming interface (API)) may receive confirmation 868, and may perform operations that render all or a selected portion of the confirmation 868 for presentation within a corresponding portion of marketplace GUI 832 via the corresponding display unit, within a confirmation page 870 that obscures all, or a selected portion, of the interface elements presented within marketplace GUI 832. For example, as illustrated within FIG. 8G, executed gaming application 302 may process confirmation 868, and may generate interface elements 872 that, when presented within confirmation page 870, confirm the allocation of the ten marketplace credits to the account of the user within the electronic marketplace (e.g., to the user's digital wallet within the electronic marketplace).

Based on confirmation 868, executed gaming application 302 may also generate, and present within confirmation page 870, one or more additional interface elements, such as icon 874, that, when selected or engaged with by the user, enable the user to access the electronic marketplace using any of the exemplary processes described herein, For example, the user may provide additional input to customer computing device 110A (e.g., via the corresponding input unit) that selects icon 874. Based on additional input data generated by the corresponding input unit, which characterizes the user's selection of icon 874, executed gaming application 302 may perform any of the exemplary processes described herein, in conjunction with SDK 304, to request and receive content associated with the electronic marketplace from marketplace platform system 130 (e.g., across network 118 via executed SDK engine 122), and to render portions of the additional content for presentation within corresponding portions of marketplace GUI 832 via the corresponding display unit.

Further, and based on confirmation data 868, executed gaming application 302 may generate, and present within confirmation page 870, one or more interface elements, such as icon 876, that, when selected or engaged with by the user, enable the user to access data characterizing a current balance of marketplace credits held by the user within the user's digital wallet. As described herein, the user may aggregate the marketplace credits across one or more gaming applications or other application programs that integrate the software development toolkit (SDK) associated with the computer-implemented marketplace platform and marketplace platform system 120, such as, but not limited to, those gaming applications or other application programs that establish immersive and interactive digital gaming environments (such as, but not limited to, web-based role-plating games or games that operate in whole or part using blockchain or distributed-ledger technologies), metaverses, or other virtualized digital environments (e.g., a “virtual world”).

For example, the user may provide additional input to customer computing device 110A (e.g., via the corresponding input unit) that selects icon 876, and based on additional input data generated by the corresponding input unit, which characterizes the user's selection of icon 874, executed gaming application 302 may perform any of the exemplary processes described herein, in conjunction with SDK 304, to request and receive data (e.g., across network 118 via executed SDK engine 122) characterizing a current balance of marketplace credits held by the user within the corresponding digital wallet from marketplace platform system 130 (e.g., updated balance data 866 maintained within data warehouse 116). In some instances, executed gaming application 302 may perform operations that render portions of the additional content for presentation within corresponding portions of marketplace GUI 832 via the corresponding display unit, e.g., within a wallet page 878 that obscures all, or a portion of, the interface elements presented within marketplace GUI 832, as illustrated in FIG. 8H.

Referring to FIG. 8H, wallet page 878 may include interface elements that identify a current balance of marketplace credits (e.g., 50,000 credits) held by the user within the digital wallet and available as either a credit against a purchase of products or services via the computer-implemented marketplace platform, or available for conversion for in-game currencies associated with any of the immersive and interactive digital gaming environments, metaverses, or other virtualized digital environments associated with the computer-implemented marketplace platform, using any of the exemplary processes described herein. For example, wallet page 878 may include interface elements 880 associated with these exemplary conversion processes, and based upon a selection by, or an engagement by, the user (e.g., via additional input provisioned to customer computing system 110A by the user), executed gaming application 302 may perform any of the exemplary processes described herein, in conjunction with SDK 304, that request a conversion of the a user-specific quantity of the available marketplace credits into the in-game currency associated with a corresponding one of the immersive and interactive digital gaming environments, metaverses, or other virtualized digital environments associated with the computer-implemented marketplace platform.

In some instances, described herein, a computing-implemented, cloud-based digital platform (e.g., as implemented via operations performed by marketplace platform system 120, one or more of retailer computing systems 112A and 112B, and additionally, or alternatively, one or more of more content-provider computing systems 114A and 114B) may be accessible directly through application programs executed at one or more computing devices, such as, but not limited to, one or more of customer computing devices 110A, 110B, and 110C. For example, each of the executed application programs may integrate a software development kit associated with the digital platform (e.g., SDK 304 integrated into application 302 executed by customer computing device 110A, etc.), which may facilitate programmatic interaction, and exchanges of data, with one or more computing systems of the digital platform (e.g., via SDK engine executed by the one or more processors of marketplace computing system 120, etc.). Further, the cloud-based digital platform may perform any of the exemplary processes described herein to match together candidate elements of digital content (such as, but not limited to, elements of digital advertising content and product advertisements, etc.) to one or more of the executed application programs and to the users of these executed application programs, and may provision the matched advertising content to the executed application programs for presentation within a corresponding platform-specific, marketplace graphical user interface (GUI).

Upon execution by computing device, each of the executed application programs may generate and present one or more elements of digital content within a corresponding application-specific digital interface, either alone or in conjunction with one or more static or dynamic interface elements. The presentation of the elements of digital content and the static or dynamic interface elements within application-specific digital interface of the computing device may, in some instance, establish an immersive, and interactive, digital environment accessible to a user of the computing device (e.g., via a corresponding one of I/O devices 203, etc.). Examples of the immersive and interactive digital environment may include, but are not limited to, a digital gaming environment (such as, but not limited to, web-based role-plating games or games that operate in whole or part using blockchain or distributed-ledger technologies) and a metaverse or other virtualized digital environment (e.g., a “virtual world) that incorporates, and couples together, the elements of digital content, the static or dynamic interface elements, and virtual or augmented reality technologies in communication with the executed application program and/or the corresponding computing device.

The digital gaming environment may, for example, be associated with a corresponding application program (e.g., a gaming application, such as gaming application 302), and computing environment 100 may include one or more computing systems associated with the computerized gaming environment or platform, such as computing systems 114A and 114B, which may perform any of the exemplary processes described herein to integrate a SDK associated with the digital platform into the gaming application (e.g., SDK 304 integrated into gaming application 302) and to provision the gaming application, and the integrated SDK, to one or more of customer computing devices 110A, 110B, and 110C. Further, in some instances, the metaverse or other virtualized digital environment may be associated with a corresponding application program (e.g., a “metaverse” application), and although not illustrated in FIG. 1, computing environment 100 may also include a computing system associated with the metaverse or other virtualized digital environment (e.g., a “metaverse” system), which may perform any of the exemplary processes described herein to integrate a SDK associated with the digital platform into a corresponding executable application program associated with the metaverse or other virtualized digital environment (hereinafter, a “metaverse” application) and to provision the metaverse application, and the integrated SDK, to one or more of customer computing devices 110A, 110B, and 110C.

In some instances, and through the integration of the SDK into the corresponding application program (e.g., the gaming application and/or the metaverse application), the execution of the corresponding application program by the one or more processors of the computing device (e.g., one or more of customer computing devices 110A, 110B, and 110C) may enable the executed application program, and a user that operates the computing device, to interact with, and to participate in, an electronic marketplace established and maintained by marketplace platform system 120 using any of the exemplary processes described herein. Further, upon execution by the one or more processors of the computing device, the executed application program (e.g., the gaming application and/or the metaverse application) may cause the computing device to present, within an application-specific digital interface, one or more elements of digital content in conjunction with one or more static or dynamic interface elements that, collectively, establish an immersive, and interactive, digital environment, such as, but not limited to, the exemplary digital gaming environments, metaverse, or virtual worlds described herein.

The static or dynamic interface elements may, for instance, represent objects or items within the digital environments (e.g., the digital gaming environments, metaverses, or virtual worlds), and examples of these static or dynamic objects or items may include, but are not limited to, static billboards within the digital environments, dynamic vehicles within the digital environments, stationary or dynamic individuals within the digital environments, or any additional or alternate static or dynamic objects or items that facilitate or enhance an ability of the user to interact with the corresponding digital gaming environments, metaverse, or virtual worlds. Further, in some examples, one or more of these static or dynamic objects or items may correspond to a selectable interface element that, upon selection by the user, triggers a presentation by the executed application program, of the marketplace GUI with the gaming interface. The marketplace GUI may, for example, obscure all or a selected portion of the digital content and interface elements establishing the digital environment, and may enable the user to interact with the electronic marketplace within exiting the digital environment.

By way of example, each the application programs may also include elements of layout data that identify and characterize corresponding ones of the elements of digital content, static interface elements, or dynamic interface elements capable of presentation within the corresponding application-specific digital interfaces, e.g., upon execution by one or more processors of customer computing devices 110A, 110B, or 110C. For instance, the digital environment may include a digital gaming environment within which a corresponding user traverses, and interacts with, a virtualized cityscape using various forms of transportation, and the corresponding application program may include elements of layout data that identify each of the elements of digital content and interface elements within the digital gaming environment (e.g., via a unique, alphanumeric identifier and corresponding description, etc.), and that specify, for each of the elements of digital content and interface elements, one or more visual characteristics, one or more positions within various portions or screens of the digital environment, and a static or dynamic character of the corresponding elements of digital content and interface elements.

Further, in some instances, and prior to provisioning the application program, and integrated SDK and layout data, to a corresponding computing device, the computing system associated with the corresponding application program (e.g., computing system 114A) may provision at least a portion of the layout data characterizing the interface elements and elements of digital content that establish the digital environment to marketplace platform system 120. Marketplace platform system 120 may, for example, process the layout data and may elect to associate one or more dynamic interface elements, such as, but not limited to, a static or dynamic interface element representative of a motorcycle accessible to the user within the digital environment, with the presentation of the marketplace GUI within the digital environment. Marketplace platform system 120 may perform operations that generate a request to associate the dynamic interface element representative of a motorcycle with the presentation of the marketplace GUI, and may transmit the generated request across communications network 118 to computing system 114A.

The request may include the unique, alphanumeric identifier of the dynamic interface element representative of the motorcycle, and computing system 114A may process the request to obtain the unique, alphanumeric identifier of the dynamic interface element, and may perform operations that augment a portion of the layout data associated with the unique, alphanumeric identifier to include data (e.g., metadata) that links the dynamic interface element representative of a motorcycle to the electronic marketplace, e.g., to “tag” the dynamic interface element representative of the motorcycle. Computing system 114A may also perform any of the exemplary processes described herein to provision the application program, and the integrated SDK and the integrated elements of layout data, across communications network 118 to a computing device operable by a user, such as customer computing device 110A.

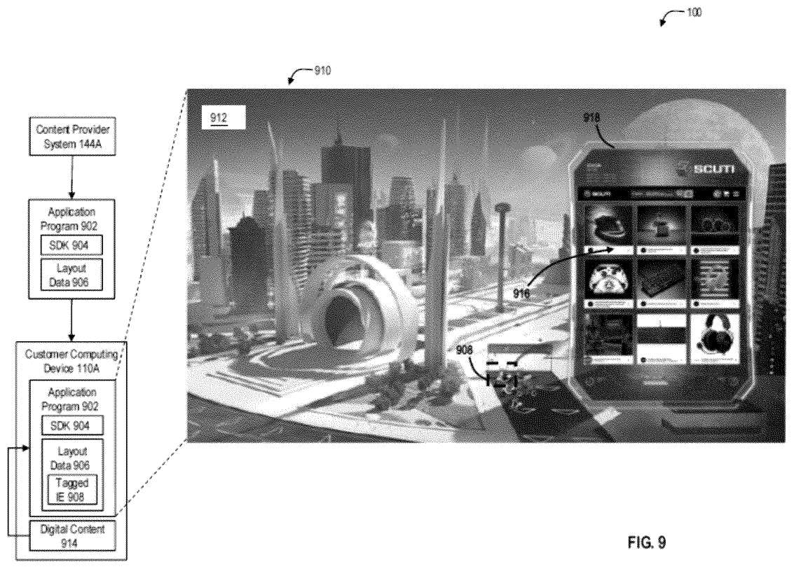

For example, referring to FIG. 9, customer computing device 110A may receive, from computing system 114A, an application program 902, which includes an integrated SDK 904 and integrated elements of layout data 906, and may store application program 902, and the integrated SDK 904 and the integrated elements of layout data 906, within a tangible, non-transitory memory. In some instances, application program 902 may, upon execution by the one or more processors of customer computing device 110A, establish a digital gaming environment within which a corresponding user traverses, and interacts with, a virtualized cityscape using various forms of transportation, and the integrated elements of layout data 906 may identify and characterize each of the elements of digital content and static or dynamic interface elements within the digital gaming environment established by executed application program 902. Further, and as described herein, the integrated elements of layout data 906 may also identify and characterize a tagged interface element 908 representative of motorcycle within the digital gaming environment and linked to the electronic marketplace.

Upon execution of application program 902, the one or more processors of customer computing device 110A may generate, present within a corresponding application-specific digital interface 910, one or more static or dynamic interface elements and elements of digital content 912 in accordance with the integrated elements of layout data 906. As described herein, the dynamic gaming environment may include a virtualized cityscape, and the user may traverse the virtualized cityscape using various forms of transportation based on input provided to application-specific digital interface 910, e.g., via I/O device 203. For example, and based on the provisioned input, the user may interact with the motorcycle associated with tagged interface element 908, and upon provisioning of further user input that clicks, taps, or otherwise selects tagged interface element 908.

Executed application program 902 may receive input data characterizing the further provisioned input, and based on the integrated elements of layout data 906, executed application program 902 may detect the user's selection of tagged interface element 908, and may perform operations that access one or more tangible, non-transitory memory and obtain one or more elements of digital content 914 from one or more tangible, non-transitory memories. As described herein, the elements of digital content 914 may include, and characterize, one or more product advertisements of potential relevance to the user, the user's prior interactions within the digital gaming environment, and/or other digital gaming environments, multiverses, or virtual worlds associated with the electronic marketplace and with marketplace computing system 120. In some instances, executed application program 902 may present additional interface elements 916 representative of all, or a selected subset, of the identified product advertisements within a marketplace graphical user interface (GUI) 918. As described herein, marketplace GUI 918 (and presented interface elements 916) may obscure all or a selected portion of the digital content 912 associated with the ongoing gaming environment established by executed gaming application 902 and presented within application-specific digital interface 910.

In some instances, the user of customer computing device 110A may peruse the products associated with the product advertisements, seek out product information, and provision further input to customer computing device 110A indicative of a request, by the user, to purchase a product or service associated with a corresponding one of the presented products advertisements without exiting the digital gaming environment. For example, the further input may be associated with a selection of a corresponding one of interface elements 916 associated with the product or service, which may add the product or service to the user's online shopping cart, and the selection of additional interface elements that initiates the purchase using the account information maintained within profile data associated with the user at marketplace platform system 120 (e.g., not illustrated in FIG. 14). In response to the further input, customer computing device 110A may transmit a purchase request to marketplace platform system 120, which may perform any of the exemplary processes described herein to complete the purchase and allocate a specific number of marketplace credits associated with the now-purchased product or service to the user. As described herein, data characterizing the allocated number of marketplace credits may be maintained within a virtual wallet of the user, e.g., as established by a virtual wallet application executed at customer computing device 110A.

Further, in some instances, customer computing device 110A may also receive input indicative of a decision, by the user, to exchange all or a selected subset of the allocated marketplace credits for available products or services (e.g., associated with the product advertisements), for digital items or objects within the digital gaming environment, or for in-game credits usable within the digital gaming environment. Based on the received input, executed application program 902 may perform any of the exemplary processes described herein, in conjunction with marketplace platform system 120 to initiate and execute the requested exchange. The user may also further input to customer computing device 110 that exits marketplace GUI 918, and based on the further input, executed gaming application 918 may perform operations that remove marketplace GUI 918 from application-specific digital interface 910, e.g., without removing the user from the digital gaming environment.

In other instances, the user may elect to peruse the products associated with the product advertisements not within the ongoing digital gaming environment (e.g., via overlaid marketplace GUI 918), but instead at a later time during the ongoing digital gaming environment, within an additional, or alternate, digital gaming environment, metaverse, or virtual world, or outside of any gaming environment, metaverse, or virtual world. Based on the user's election, the user may provide input to customer computing device 110A (e.g., by selecting a further interface element of marketplace GUI 918), which causes executed application program 902 to store locally within a tangible, non-transitory memory the elements of digital content 914, e.g., as a list of favorite products or rewards that may be accessible to the user upon a subsequent manual launch of marketplace GUI 918 using any of the exemplary processes described herein.

The exemplary processes described herein may enable marketplace platform system 120 to establish and maintain, on behalf of the user, a universal account that links together the user and both the number of allocated marketplace credits available for redemption, and those available product advertisements and rewards (e.g., the “favorites” list) across various digital gaming environments, metaverses, and virtual worlds established by application programs associated with the electronic marketplace. These exemplary processes may, for example, establish interoperable digital wallets, with which users may interact and earn rewards and marketplace credits within one digital gaming environment, metaverse, or virtual world, and redeem those marketplace credits or rewards within any additional, or alternate, digital gaming environment, metaverse, or virtual world associated with the electronic marketplace.

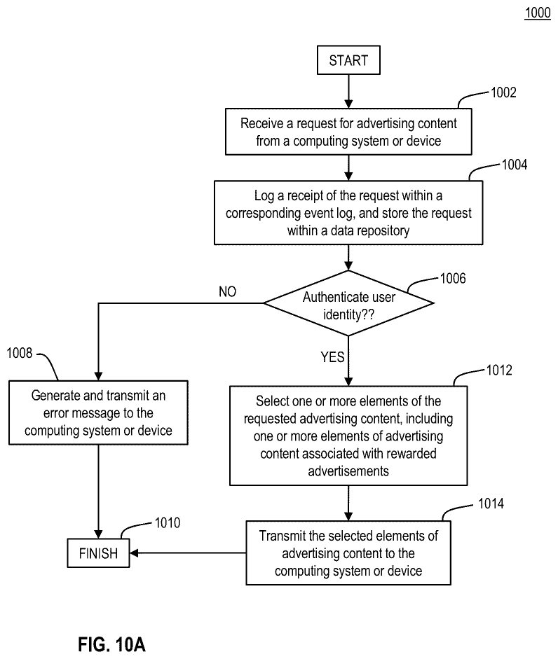

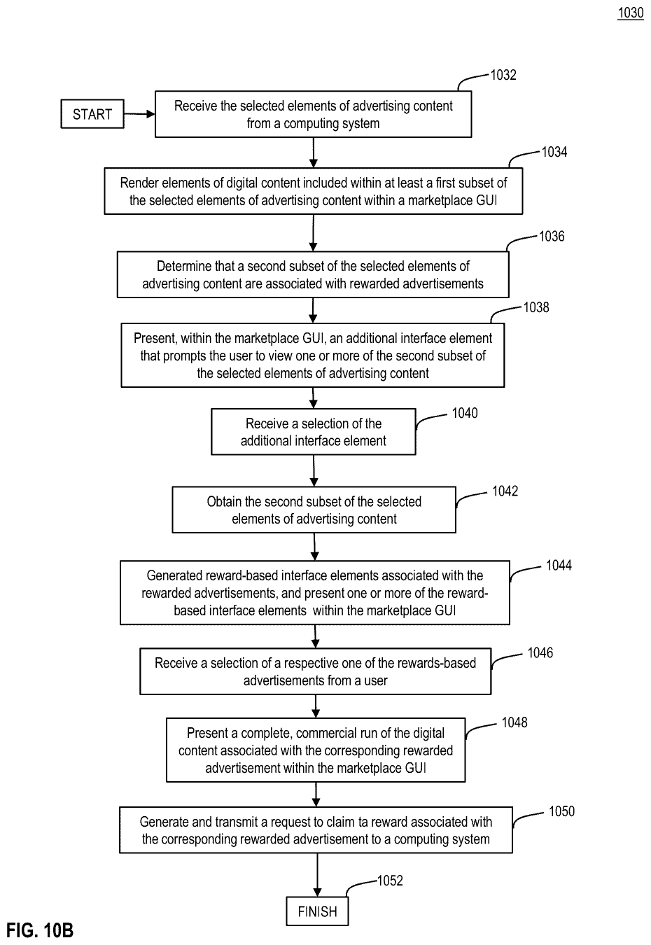

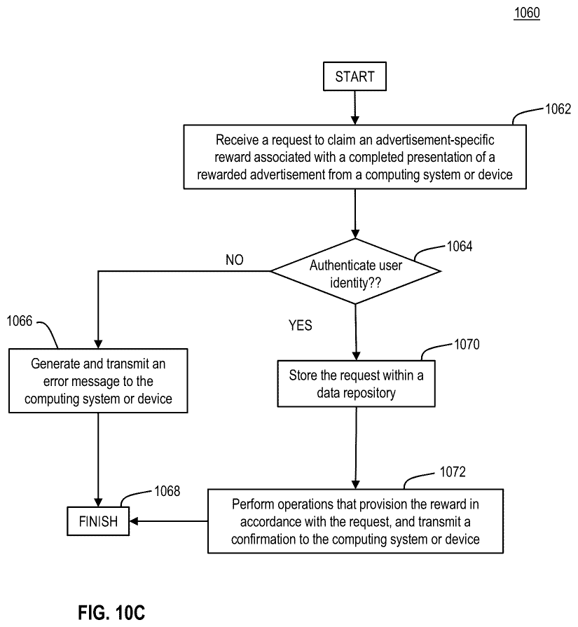

FIGS. 10A, 10B, and 10C are flowcharts of exemplary processes for integrating computer-implemented digital platforms into programmatic virtual environments. In some examples, a computing system operating within computing environment 100, such as marketplace platform system 120, may perform one or more of the exemplary steps of process 1000 illustrated in FIG. 10A and process 1060 illustrated in FIG. 10C, and an application program executed by one or more devices or computing systems operating within computing environment 100, such as gaming application 302 or application program 902 executed by customer computing system 110A, may perform one or more of the exemplary steps of process 1030 illustrated in FIG. 10B.

Referring to FIG. 10A, marketplace computing system 120 may receive a request for digital content from a computing system or device operating within computing environment 100, such as customer computing device 110A (e.g., in step 1002). As described herein, customer computing device 110A may be operable by a user, and the received request may be generated by an application program executed by customer computing device 110A, such as, but not limited to, executed gaming application 302 or executed application program 1002. Further, and as described herein, the received request may correspond to a request for advertising content appropriate to the user (e.g., via corresponding elements of profile data, etc.), the user's prior interactions with marketplace platform system 120 and the computer-implemented marketplace associated with marketplace platform system 120, and additionally, or alternatively, with executed gaming application 302 or executed application program 902.

In some instances, the received request may include, among other things, elements of event data that identifies the user (e.g., via corresponding, alphanumeric authentication credentials, a digital token, etc.) and further, that also identifies and characterizes an activity of the user within the gaming environment associated with, and established by, executed gaming application 302, or within the virtual environment associated with, and established by, executed application program 1002. By way of example, the gaming environment may be associated with a plurality of discrete, and increasing challenging, levels of gameplay, and portions of the event data may indicate a completion of a corresponding one of the levels of gameplay and include information, such as level data that identifies the completed level of gameplay and additionally or alternatively, characterizes a complexity of the completed level of gameplay.

Marketplace computing system 120 may also perform any of the exemplary processes described herein to log the receipt of the request within a corresponding event log, and may store the request within a corresponding portion of a locally or remotely accessible data repository, such as data warehouse 116 (e.g., in step 1004). Further, and based on portions of the event data that identify the user, and based on locally maintained elements of authentication data, marketplace computing system 120 may also perform any of the exemplary processes described herein to authenticate an identity of the user (e.g., in step 1006). If, for example, marketplace computing system 120 were unable to authenticate the identity of the user (e.g., in step 1006; NO), marketplace computing system 120 may perform operations that generate an error message indicative of the failed authentication, and transmit the error message across network 118 to the computing system or device associated with the request, such as customer computing device 110A (e.g., in step 1008). By way of example, marketplace platform system 120 may establish in step 100 that a marketplace account does not exist exists for the user, and in some instances, the transmitted error message may include data that, when presented to the user within a corresponding digital interface by executed gaming application 302 or executed application program 902, prompts the user to create a marketplace account. Exemplary process 1000 is then complete in step 1010.

Alternatively, if marketplace computing system 120 were able to authenticate the identity of the user (e.g., in step 1006; YES), marketplace computing system 120 may perform any of the exemplary processes described herein to select one or more elements of the requested digital content (e.g., in step 1012). By way of example, the requested digital content may include advertising content, and in step 1012, marketplace computing system 120 may perform any of the exemplary processes described herein to select elements of the advertising content that would be appropriate to the user, to the user's prior interactions with marketplace platform system 120 and the computer-implemented marketplace associated with marketplace platform system 120, and/or to the gaming environment established by and associated with executed gaming application 302, e.g., to the completed level of gameplay and the complexity of that completed level of gameplay. In additional, or alternate examples, marketplace computing system 120 may perform any of the exemplary processes described herein in step 1012 to select elements of the advertising content that would be appropriate to the user, to the user's prior interactions with marketplace platform system 120 and the computer-implemented marketplace associated with marketplace platform system 120, and/or to the virtual environment established by and associated with executed application program application 902.

By way of example, marketplace computing system 120 may perform any of the exemplary processes described herein to identify or select, in step 1012, one or more “candidate” elements of advertisement content appropriate to the user, the user's prior interactions with marketplace platform system 120 and the computer-implemented marketplace associated with marketplace platform system 120, and additionally, or alternatively, with executed gaming application 302 (or executed application program 902) based on an application of a trained machine learning (ML) or artificial intelligence (AI) process to a dynamically determined set of input data (e.g., as selected via feature engineering, etc.). Examples of the ML or AI models may include, but are not limited to, a deep neural network and one or more decision tree models, such as a boosted decision tree model. Further, the set of input data may include, but is not limited to: one or more elements of profile data characterizing the user; one or more of the elements of event data and level data characterizing the user's prior interaction with executed gaming application 302; one or more elements of historical interaction data characterizing prior interactions between the user and the computer-implemented marketplace (e.g., data indicating previous activity with the marketplace, such as historical impressions or purchases); elements of application or gaming data associated with executed gaming application 302 or application program 902 (e.g., rules or requirements game developers configure when adding gaming application 302 or application program 902 (to the marketplace network); and/or elements of retailer data (e.g., rules or requirements retailers configure when adding a product to the computer-implemented electronic marketplace).

Further, in step 1012, marketplace platform system 120 may also perform any of the exemplary processes described herein to select all, or a corresponding subset, of the candidate elements of advertisement content for provisioning customer computing system 110A in response to the received request. For example, marketplace platform system 120 may perform operations, described herein, that select all, or the corresponding subset, of the candidate elements of advertising content for provisioning to customer computing system 110A based on an application of one or more random selection processes to the candidate elements of advertising content. Examples of these random selection processes may include, but are not limited to, a simple random sampling process (e.g., an equal probability sampling process, a selection-rejection process, a reservoir sampling process, etc.), a systemic random sampling process, a stratified sampling process, or a cluster sampling process.

As described herein, each of the selected elements of advertising content may characterize a corresponding product-, service-, and/or retailer-specific advertisement, and may include corresponding elements of digital content that, when rendered for presentation within marketplace GUI 832 by executed gaming application 302 (or within marketplace GUI 918 by executed application program 902), identify and characterize the corresponding product-, service-, and/or retailer-specific advertisement. Examples of the elements of digital content associated with selected elements of advertising content elements may include, but are not limited to, a static digital image, a GIF, or a digital video of a predetermined length (e.g., a commercial run of fifteen seconds, thirty seconds, sixty seconds, etc.)

Further, as described herein, the product-, service-, and/or retailer-specific advertisements may include one or more “rewarded” advertisements, and each of the one or more rewarded advertisements may be associated with a corresponding, product-, service-, and/or retailer-specific prize or “reward” (e.g., an “advertisement-specific” reward). Examples of the advertisement-specific rewards may include, but are not limited to, one or more units of the exemplary marketplace credits described herein, which may be redeemed through any of the gaming environments (or other digital or virtual environments, such as metaverses) associated and operable with the electronic marketplace established and maintained by marketplace platform system 120. Further, examples of the advertisement-specific reward or prize may also include, but are not limited to, a discount on a retail price of the corresponding product or service, or on a specified quantity of the corresponding product or service (e.g., a “buy one, get one” at a predetermined discount, etc.), when purchased through the electronic marketplace, a sample of the corresponding product or service available for provisioning through the electronic marketplace, or any additional, or alternate, promotional offer associated with the corresponding product, service, or merchant or retailer. By way of example, each rewarded advertisement may be associated with a corresponding one of the selected elements of advertising content, which may include elements of digital content that characterize the respective rewarded advertisement (e.g., the static digital image, GIF, digital video of the predetermined length) and elements of reward data that identify and the characterize the corresponding, advertisement-specific reward available for allocation to the user.

Referring back to FIG. 10A, marketplace platform system 120 may also perform any of the exemplary processes described herein to transmit the selected elements of advertising content (e.g., the requested digital content) across network 120 to customer computing device 110A, e.g., as a response to the received request (e.g., in step 1014). Exemplary process 1000 is then complete in step 1010.

Referring to FIG. 10B, the computing system or device associated with the request, such as, but not limited to, customer computing system 110A, may receive the selected elements of advertising content (e.g., the requested digital content), and may store the selected elements of advertising content within a locally or remotely accessible data repository (e.g., in step 1032). Computing system 110A may also perform any of the exemplary processes described herein, in step 1034, to render the elements of digital content included within at least a first subset of the selected elements of advertising content, and other locally maintained elements of digital content, for presentation within portions of a platform-specific digital interface, such as a marketplace GUI 832 (e.g., via executed gaming application 302) or marketplace GUI 918 (e.g., via executed application program 902).

Further, and as described herein, at least a second subset of the selected elements of advertising content may be associated with, and may characterize, rewarded advertisement, which may be associated with a corresponding, advertisement-specific reward available for allocation to the user upon a complete presentation of the corresponding element of advertising content. In some instances, customer computing system 110A may perform any of the exemplary processes described herein to detect a presence of the second subset within the selected elements of advertising content (e.g., in step 1036), and based on the detection of the second subset, customer computing system 110A may perform any of the exemplary processes described herein to present, within marketplace GUI 832 or 918, an additional interface element that prompts the user to view one or more of the second subset of the selected elements of advertising content associated with the rewarded advertisements (e.g., in step 1038).

In some examples, customer computing system 110A may perform any of the exemplary processes described herein to receive input data indicating the user's selection of, or engagement with, the additional interface element and the user's election to view one or more of the rewarded advertisements (e.g., in step 1040). Based on the input data characterizing the selection of, or the engagement with, the additional interface element (e.g., which may be generated by the corresponding input unit in response to the receipt of the additional input), customer computing system 110A may perform any of the exemplary processes described herein to obtain the second subset of the selected elements of advertising content from the locally or remotely accessible data repository (e.g., in step 1042). Customer computing system 110A may perform any of the exemplary processes described herein that, for one or more of the second subset of the elements of advertising, generate an interface element (e.g., a reward-based interface element) associated with a corresponding one of the rewarded advertisements, and that present the one or more reward-based interface elements within a corresponding portion of marketplace GUI 832 or 918 (e.g., in step 1044).

As described herein, the user may elect to view the rewarded advertisement associated with one, or more, of the rewards-based interface elements presented within marketplace GUI 832 or 918, and customer computing system 110A may perform any of the exemplary processes described herein to receive data indicating the user's selection of, or engagement with, a respective one of the rewards-based interface elements presented within marketplace GUI 832 or 918 (e.g., in step 1046). Based on the received data, customer computing system 110A may perform any of the exemplary processes described herein to access the corresponding one of the second subset of the selected elements of advertising content associated with the respective, rewards-based interface element, and present the digital content associated with the corresponding rewarded advertisement (e.g., the digital image, the GIF, or the digital video described herein) within marketplace GUI 832 or 918 (e.g., in step 1048). In some instances, customer computing system 110A may perform any of the exemplary processes described herein to present the complete, commercial run of the digital content associated with the corresponding rewarded advertisement within a pop-up window (e.g., advertisement page 850) that obscures all, or a selected portion, of marketplace GUI 832 or 918.

Upon completion of the complete, commercial run of the digital content associated with the corresponding, rewarded advertisement, customer computing system 110A may perform any of the exemplary processes described herein to generate, and transmit to marketplace platform system 120, a request to “claim” the advertisement-specific reward associated with the completed presentation of the corresponding rewarded advertisement (e.g., in step 1050). As described herein, the request may include elements of rewards data that identify and characterize the advertisement-specific reward (e.g., as maintained within the corresponding one of the second subset of the selected elements of advertising content associated with the respective, rewards-based interface element) and a unique identifier of the user (e.g., alphanumeric authentication credentials, an account identifier, a digital token, etc.). Exemplary process 1030 is then complete in step 1052.

Referring to FIG. 10C, marketplace platform system 120 may receive the request to “claim” the advertisement-specific reward associated with the completed presentation of the corresponding rewarded advertisement from a computing system or device, such as customer computing system 110A (e.g., in step 1062). As described herein, the request may include elements of rewards data that identify and characterize the advertisement-specific reward and a unique identifier of a user (e.g., alphanumeric authentication credentials, an account identifier, a digital token, etc.), and marketplace platform system 120 may perform any of the exemplary processes described herein to authenticate an identity of the user, and to determine whether the user represents a registered user of the electronic marketplace (e.g., in step 1064). If, for example, marketplace platform system 120 were to determine that the user does not represent a registered user of the electronic marketplace, or alternatively, that the user represents a registered user of the electronic marketplace that is not currently logged into the electronic marketplace (e.g., step 1064; NO), marketplace platform system 120 may perform any of the exemplary processes described herein to generate and transmit an error message across network 118 to the computing system or device (e.g., in step 1066). By way of example, the error message may include information that, when presented to the user within a corresponding digital interface by executed gaming application 302 or executed application program 902, prompts the user to the electronic marketplace or alternatively, prompts the user to provide further input to customer computing device 110A that initiates a registration of the user for an account at the electronic marketplace. Exemplary process 1060 is then complete in step 1068.

Alternatively, if marketplace platform system 120 were to determine that the user represents a registered user of the electronic marketplace, and that the user represents a registered user that is currently logged into the electronic marketplace (e.g., step 1064; YES), marketplace platform system 120 may authenticate the user's identity and perform any of the exemplary processes described herein to store the received request within the locally or remotely accessible data repository (e.g., in step 1070). Marketplace platform system 120 may perform any of the exemplary processes described herein to provision the advertisement-specific reward to the user in accordance with the elements of rewards data, and to generate a confirmation message indicative of the provisioning of the advertisement-specific reward to the user, which marketplace platform system 120 may transmit across network 120 to customer computing system 110A (e.g., in step 1072). Exemplary process 1060 is then complete in step 1068.

### B. Exemplary Hardware and Software Implementations

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Exemplary embodiments of the subject matter described in this specification, including, but not limited to, SDK engine 122, recommendation engine 124, marketplace dashboard engine 126, commerce services engine 128, AI 130, event service engine 134, product management engine 134, user identity engine 136, external services engine 138, gaming applications 302 and 902, software development kits (SDKs) 304 and 904, shipping service integration module 342, external AI services module 344, vendor e-commerce service module 346, and external partner interface module 348, and content selection module 810, can be implemented as one or more computer programs, i.e., one or more modules of computer program instructions encoded on a tangible non transitory program carrier for execution by, or to control the operation of, a data processing apparatus (or a computer system).

Additionally, or alternatively, the program instructions can be encoded on an artificially generated propagated signal, such as a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The terms “apparatus,” “device,” and “system” refer to data processing hardware and encompass all kinds of apparatus, devices, and machines for processing data, including, by way of example, a programmable processor such as a graphical processing unit (GPU) or central processing unit (CPU), a computer, or multiple processors or computers. The apparatus, device, or system can also be or further include special purpose logic circuitry, such as an FPGA (field programmable gate array) or an ASIC (application-specific integrated circuit). The apparatus, device, or system can optionally include, in addition to hardware, code that creates an execution environment for computer programs, such as code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, such as one or more scripts stored in a markup language document, in a single file dedicated to the program in question, or in multiple coordinated files, such as files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, such as an FPGA (field programmable gate array), an ASIC (application-specific integrated circuit), one or more processors, or any other suitable logic.

Computers suitable for the execution of a computer program include, by way of example, general or special purpose microprocessors or both, or any other kind of central processing unit. Generally, a CPU will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, such as magnetic, magneto-optical disks, or optical disks. However, a computer need not have such devices. Moreover, a computer can be embedded in another device, such as a mobile telephone, a personal digital assistant (PDA), a mobile audio or video player, a game console, a Global Positioning System (GPS) receiver, or a portable storage device, such as a universal serial bus (USB) flash drive, to name just a few.

Computer-readable media suitable for storing computer program instructions and data include all forms of non-volatile memory, media and memory devices, including by way of example semiconductor memory devices, such as EPROM, EEPROM, and flash memory devices; magnetic disks, such as internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display unit, such as a CRT (cathode ray tube) or LCD (liquid crystal display) monitor, for displaying information to the user and a keyboard and a pointing device, such as a mouse or a trackball, by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, such as a data server, or that includes a middleware component, such as an application server, or that includes a front-end component, such as a computer having a graphical user interface or a web browser through which a user can interact with an implementation of the subject matter described in this specification, or any combination of one or more such back-end, middleware, or front-end components. The components of the system can be interconnected by any form or medium of digital data communication, such as a communication network. Examples of communication networks include a local area network (LAN) and a wide area network (WAN), such as the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, such as an HTML page, to a user device, such as for purposes of displaying data to and receiving user input from a user interacting with the user device, which acts as a client. Data generated at the user device, such as a result of the user interaction, can be received from the user device at the server.

While this specification includes many specifics, these should not be construed as limitations on the scope of the invention or of what may be claimed, but rather as descriptions of features specific to particular embodiments of the invention. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

Various embodiments have been described herein with reference to the accompanying drawings. It will, however, be evident that various modifications and changes may be made thereto, and additional embodiments may be implemented, without departing from the broader scope of the disclosed embodiments as set forth in the claims that follow. It is intended, therefore, that this disclosure and the examples herein be considered as exemplary only, with a true scope and spirit of the disclosed embodiments being indicated by the following listing of exemplary claims.

What is claimed is:

1. An apparatus, comprising:
a transceiver device;
a non-transitory, computer-readable medium storing instructions; and
at least one processor coupled to the-transceiver device and the computer-readable medium, the at least one processor being configured to execute the instructions to:
receive a first signal from a computing device via the-transceiver device, the computing device being operable by a user, and the first signal being generated by an application program executed by the computing device;
determine that a first element of digital content is consistent with at least one prior interaction between the user and a first digital interface of a digital platform associated with a plurality of application programs, the plurality of application programs comprising the executed application program.
transmit, via the transceiver device, a second signal that includes the element of first digital content to the computing device, the executed application program causing the computing device to present second elements of digital content within a second digital interface associated with the executed application program, to present the first element of digital content within the second digital interface at a position that obscures at least one of the second elements of digital content, and to generate a request for an exchange of data associated with first element of digital content without exiting a virtual environment associated with the executed application program; and
receive, via the transceiver device, a third signal that includes the request from the computing device, and perform operations that execute the data exchange in accordance with the request.

2. An apparatus, comprising:
a transceiver device;
a non-transitory, computer-readable medium storing instructions; and
at least one processor coupled to the transceiver device and the computer-readable medium, the at least one processor being configured to execute the instructions to:
receive a first signal from a computing device via the-transceiver device, the computing device being operable by a user, and the first signal being generated by an application program executed by the computing device;
determine that a first element of digital content is consistent with at least one prior interaction between the user and a first digital interface of a digital platform associated with a plurality of application programs, the first element of digital content being associated with an exchange of data involving the digital platform;
transmit, to the computing device via the transceiver device, a second signal that includes the element of first digital content and information characterizing the data exchange, the executed application program causing the computing device to present second elements of digital content within a second digital interface associated with the executed application program, to present the first element of digital content within the second digital interface at a position that obscures at least one of the second elements of digital content, and based on the presentation of the first element of digital content, to generate a request to initiate the data exchange associated with first element of digital content without exiting a virtual environment associated with the executed application program; and
receive, via the transceiver device, a third signal that includes the request from the computing device, and perform operations that execute the data exchange in accordance with the request.

3. A computer-implemented method, comprising:
receiving a first signal from a computing device using at least one processor, the computing device being operable by a user, and the first signal being generated by an application program executed by the computing device;
determining, using the at least one processor, that a first element of digital content is consistent with at least one prior interaction between the user and a first digital interface of a digital platform associated with a plurality of application programs, the first element of digital content being associated with an exchange of data involving the digital platform;
transmitting, to the computing device using the at least one processor, a second signal that includes the element of first digital content and information characterizing the data exchange, the executed application program causing the computing device to present second elements of digital content within a second digital interface associated with the executed application program, to present the first element of digital content within the second digital interface at a position that obscures at least one of the second elements of digital content, and based on the presentation of the first element of digital content, to generate a request to initiate the data exchange associated with first element of digital content without exiting a virtual environment associated with the executed application program; and
using the at least one processor, receiving a third signal that includes the request from the computing device, and performing operations that execute the data exchange in accordance with the request.
